(19) United States
(12) Patent Application Publication
(10) Pub. No.: US 2025/0317716 A1
(43) Pub. Date: Oct. 9, 2025

(54) SENSING METHOD AND APPARATUS, AND DEVICE

(71) Applicant: VIVO MOBILE COMMUNICATION CO., LTD., Dongguan (CN)

(72) Inventors: Jianzhi LI, Dongguan (CN); Dajie JIANG, Dongguan (CN)

(21) Appl. No.: 19/243,760

(22) Filed: Jun. 20, 2025

Related U.S. Application Data
(63) Continuation of application No. PCT/CN2023/139333, filed on Dec. 18, 2023.

(30) Foreign Application Priority Data
Dec. 21, 2022 (CN) 202211651936.1

(51) Int. Cl. H04W 4/38; H04B 7/06; H04W 24/10

(52) U.S. Cl. CPC H04W 4/38; H04B 7/0626; H04W 24/10

(57) ABSTRACT

This application discloses a sensing method and apparatus, and a device, and belongs to the field of communication technologies. The sensing method includes: A first device receives a first signal sent by a second device, where the first signal is used for random phase measurement of an antenna port of the second device, the second device is a terminal, and the second device is a transmitting node of a signal related to a sensing service or an integrated sensing and communication service; the first device performs random phase measurement based on the first signal, to obtain a first random phase measurement result; and the first device performs a first operation, where the first operation includes at least one of the following: sending the first random phase measurement result to the second device or a third device; or performing a sensing-related operation based on the first random phase measurement result.

### CROSS-REFERENCE TO RELATED APPLICATIONS

This application is a continuation of International Patent Application No. PCT/CN2023/139333, filed on Dec. 18, 2023, which claims priority to Chinese Patent Application No. 202211651936.1, filed on Dec. 21, 2022 in China, which is incorporated herein by reference in its entirety.

### TECHNICAL FIELD

This application belongs to the field of communication technologies, and in particular, to a sensing method and apparatus, and a device.

### BACKGROUND

In a related art, a sensing node in a mobile communication network may achieve sensing measurement of a state or a sensing environment of a sensing target by sending and receiving a sensing signal. In integrated sensing and communication (Integrated Sensing and Communication, ISAC), it is particularly important to obtain accurate measurement information.

However, non-ideal factors of a device and a hardware circuit of user equipment (User Equipment, UE) (the UE is also referred to as a terminal below) may significantly affect measurement accuracy. In a sensing manner of sending and receiving a sensing signal between a base station and a terminal, extracting channel state information (Channel State Information, CSI) for sensing is one of main implementations of integrated sensing and communication. However, some non-ideal factors may cause errors in CSI measurement, significantly affecting sensing accuracy. For example, currently, when channel estimation is performed based on a reference signal (for example, a sounding reference signal (Sounding Reference Signal, SRS)), phases of uplink channel estimation at a base station side are discontinuous in time, that is, there is a random phase offset of channel estimation at different uplink moments. If user equipment (User Equipment, UE) has more than one radio frequency channel, different random phases are introduced to different radio frequency channels.

### SUMMARY

According to a first aspect, a sensing method is provided, and the method includes:

A first device receives a first signal sent by a second device, where the first signal is used for random phase measurement of an antenna port of the second device, the second device is a terminal, and the second device is a transmitting node of a signal related to a sensing service or an integrated sensing and communication service;
the first device performs random phase measurement based on the first signal, to obtain a first random phase measurement result; and
the first device performs a first operation, where the first operation includes at least one of the following:
sending the first random phase measurement result to the second device or a third device, the first device being a network side device, the third device being a terminal, and the third device being a receiving node of the signal related to the sensing service or the integrated sensing and communication service; or
performing a sensing-related operation based on the first random phase measurement result.

According to a second aspect, a sensing apparatus is provided, and the apparatus includes:
a first receiving module, configured to receive a first signal sent by a second device, where the first signal is used for random phase measurement of an antenna port of the second device, the second device is a terminal, and the second device is a transmitting node of a signal related to a sensing service or an integrated sensing and communication service;
a first measurement module, configured to perform random phase measurement based on the first signal, to obtain a first random phase measurement result; and
a first execution module, configured to perform a first operation, where the first operation includes at least one of the following:
sending the first random phase measurement result to the second device or a third device, the first device being a network side device, the third device being a terminal, and the third device being a receiving node of the signal related to the sensing service or the integrated sensing and communication service; or
performing a sensing-related operation based on the first random phase measurement result.

According to a third aspect, a sensing method is provided, and the method includes:

A second device obtains first configuration information, where the first configuration information is used for random phase measurement of an antenna port of the second device, the second device is a terminal, and the second device is a transmitting node of a signal related to a sensing service or an integrated sensing and communication service; and
the second device sends a first signal based on the first configuration information, where the first signal is used for random phase measurement of the antenna port of the second device.

According to a fourth aspect, a sensing apparatus is provided, and the apparatus includes:
a fourth obtaining module, configured to obtain first configuration information, where the first configuration information is used for random phase measurement of an antenna port of the second device, the second device is a terminal, and the second device is a transmitting node of a signal related to a sensing service or an integrated sensing and communication service; and
a second sending module, configured to send a first signal based on the first configuration information, where the first signal is used for random phase measurement of the antenna port of the second device.

According to a fifth aspect, a sensing method is provided, and the method includes:
A third device receives a second signal sent by a second device, where the second signal is a signal related to a sensing service or an integrated sensing and communication service, the third device is a terminal, and the third device is a receiving node of the signal related to the sensing service or the integrated sensing and communication service;
the third device obtains a second random phase measurement result, where the second random phase measurement result is a random phase measurement result obtained through measurement based on the second signal; and
the third device determines a measurement value of a sensing measurement quantity based on the second random phase measurement result and the second signal.

According to a sixth aspect, a sensing apparatus is provided, and the apparatus includes:
a fifth receiving module, configured to receive a second signal sent by a second device, where the second signal is a signal related to a sensing service or an integrated sensing and communication service, the third device is a terminal, and the third device is a receiving node of the signal related to the sensing service or the integrated sensing and communication service;
a sixth obtaining module, configured to obtain a second random phase measurement result, where the second random phase measurement result is a random phase measurement result obtained through measurement based on the second signal; and
a fifth determining module, configured to determine a measurement value of a sensing measurement quantity based on the second random phase measurement result and the second signal.

According to a seventh aspect, a first device is provided. The first device includes a processor and a memory, the memory stores a program or instructions executable on the processor, and the program or the instructions, when executed by the processor, implement the steps of the method according to the first aspect.

According to an eighth aspect, a first device is provided, including a processor and a communication interface, and the communication interface is configured to receive a first signal sent by a second device, where the first signal is used for random phase measurement of an antenna port of the second device, the second device is a terminal, and the second device is a transmitting node of a signal related to a sensing service or an integrated sensing and communication service; the processor is configured to perform random phase measurement based on the first signal, to obtain a first random phase measurement result; and the processor is further configured to perform a first operation, where the first operation includes at least one of the following: sending the first random phase measurement result to the second device or a third device, the first device being a network side device, the third device being a terminal, and the third device being a receiving node of the signal related to the sensing service or the integrated sensing and communication service; or performing a sensing-related operation based on the first random phase measurement result.

According to a ninth aspect, a second device is provided. The second device includes a processor and a memory, the memory stores a program or instructions executable on the processor, and the program or the instructions, when executed by the processor, implement the steps of the method according to the third aspect.

According to a tenth aspect, a second device is provided, including a processor and a communication interface, and the processor is configured to obtain first configuration information, where the first configuration information is used for random phase measurement of an antenna port of the second device, the second device is a terminal, and the second device is a transmitting node of a signal related to a sensing service or an integrated sensing and communication service; and the communication interface is configured to send a first signal based on the first configuration information, where the first signal is used for random phase measurement of the antenna port of the second device.

According to an eleventh aspect, a third device is provided. The third device includes a processor and a memory, the memory stores a program or instructions executable on the processor, and the program or the instructions, when executed by the processor, implement the steps of the method according to the fifth aspect.

According to a twelfth aspect, a third device is provided, including a processor and a communication interface, and the communication interface is configured to receive a second signal sent by a second device, where the second signal is a signal related to a sensing service or an integrated sensing and communication service, the third device is a terminal, and the third device is a receiving node of the signal related to the sensing service or the integrated sensing and communication service; the processor is configured to obtain a second random phase measurement result, where the second random phase measurement result is a random phase measurement result obtained through measurement based on the second signal; and the processor is further configured to determine a measurement value of a sensing measurement quantity based on the second random phase measurement result and the second signal.

According to a thirteenth aspect, a sensing system is provided, including a first device and a second device. The first device may be configured to perform the steps of the sensing method according to the first aspect, and the second device may be configured to perform the steps of the sensing method according to the third aspect.

According to a fourteenth aspect, a readable storage medium is provided. The readable storage medium stores a program or instructions, and the program or the instructions, when executed by a processor, implement the steps of the method according to the first aspect, or implement the steps of the method according to the third aspect, or implement the steps of the method according to the fifth aspect.

According to a fifteenth aspect, a chip is provided. The chip includes a processor and a communication interface. The communication interface is coupled to the processor. The processor is configured to run a program or instructions, to implement the steps of the method according to the first aspect, or to implement the steps of the method according to the third aspect, or to implement the steps of the method according to the fifth aspect.

According to a sixteenth aspect, a computer program/program product is provided, where the computer program/program product is stored in a storage medium, and the computer program/program product, when executed by at least one processor, implements the steps of the method according to the first aspect, or implements the steps of the method according to the third aspect, or implements the steps of the method according to the fifth aspect.

### BRIEF DESCRIPTION OF THE DRAWINGS

FIG. 1 is a block diagram of a wireless communication system to which the embodiments of this application are applicable;

FIG. 2 is a schematic diagram of a sensing manner;

FIG. 3a is a schematic diagram of a time-frequency domain location of a signal in random phase measurement;

FIG. 3b is a first schematic diagram of reference path parameter extraction;

FIG. 3c is a first schematic diagram of random phase deflection;

FIG. 4a is a schematic diagram of random phases of different antenna ports;

FIG. 4b is a second schematic diagram of reference path parameter extraction;

FIG. 4c is a second schematic diagram of random phase deflection;

FIG. 5 is a flowchart of a sensing method according to an embodiment of this application;

FIG. 6 is a flowchart of another sensing method according to an embodiment of this application;

FIG. 7 is a flowchart of still another sensing method according to an embodiment of this application;

FIG. 8a is a first schematic diagram of an interactive process of random phase estimation and sensing measurement according to an embodiment of this application;

FIG. 8b is a second schematic diagram of an interactive process of random phase estimation and sensing measurement according to an embodiment of this application;

FIG. 8c is a third schematic diagram of an interactive process of random phase estimation and sensing measurement according to an embodiment of this application;

FIG. 8d is a fourth schematic diagram of an interactive process of random phase estimation and sensing measurement according to an embodiment of this application;

FIG. 9a is a first schematic diagram of signal configuration of random phase measurement according to an embodiment of this application;

FIG. 9b is a second schematic diagram of signal configuration of random phase measurement according to an embodiment of this application;

FIG. 10a is a fifth schematic diagram of an interactive process of random phase estimation and sensing measurement according to an embodiment of this application;

FIG. 10b is a sixth schematic diagram of an interactive process of random phase estimation and sensing measurement according to an embodiment of this application;

FIG. 10c is a seventh schematic diagram of an interactive process of random phase estimation and sensing measurement according to an embodiment of this application;

FIG. 10d is an eighth schematic diagram of an interactive process of random phase estimation and sensing measurement according to an embodiment of this application;

FIG. 11 is a structural diagram of a sensing apparatus according to an embodiment of this application;

FIG. 12 is a structural diagram of another sensing apparatus according to an embodiment of this application;

FIG. 13 is a structural diagram of still another sensing apparatus according to an embodiment of this application;

FIG. 14 is a structural diagram of a communication device according to an embodiment of this application;

FIG. 15 is a structural diagram of a terminal according to an embodiment of this application; and

FIG. 16 is a structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in the specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. In addition, objects distinguished by “first” and “second” are generally of a same type, and the number of objects is not limited, for example, there may be one or more first objects. In addition, in the specification and the claims, “and/or” represents at least one of connected objects, and the character “/” generally represents an “or” relationship between associated objects.

It should be noted that technologies described in the embodiments of this application are not limited to a Long Term Evolution (Long Term Evolution, LTE)/LTE-Advanced (LTE-Advanced, LTE-A) system, and may be further applied to other wireless communication systems such as Code Division Multiple Access (Code Division Multiple Access, CDMA), Time Division Multiple Access (Time Division Multiple Access, TDMA), Frequency Division Multiple Access (Frequency Division Multiple Access, FDMA), Orthogonal Frequency Division Multiple Access (Orthogonal Frequency Division Multiple Access, OFDMA), Single-carrier Frequency Division Multiple Access (Single-carrier Frequency Division Multiple Access, SC-FDMA), and other systems. The terms “system” and “network” in the embodiments of this application may be used interchangeably. The described technologies can be applied to both the systems and the radio technologies mentioned above as well as to other systems and radio technologies. The following descriptions describe a new radio (New Radio, NR) system for example purposes, and NR terms are used in most of the following descriptions, but these technologies can also be applied to an application other than an NR system application, for example, a 6^{th} generation (6^{th} Generation, 6G) communication system.

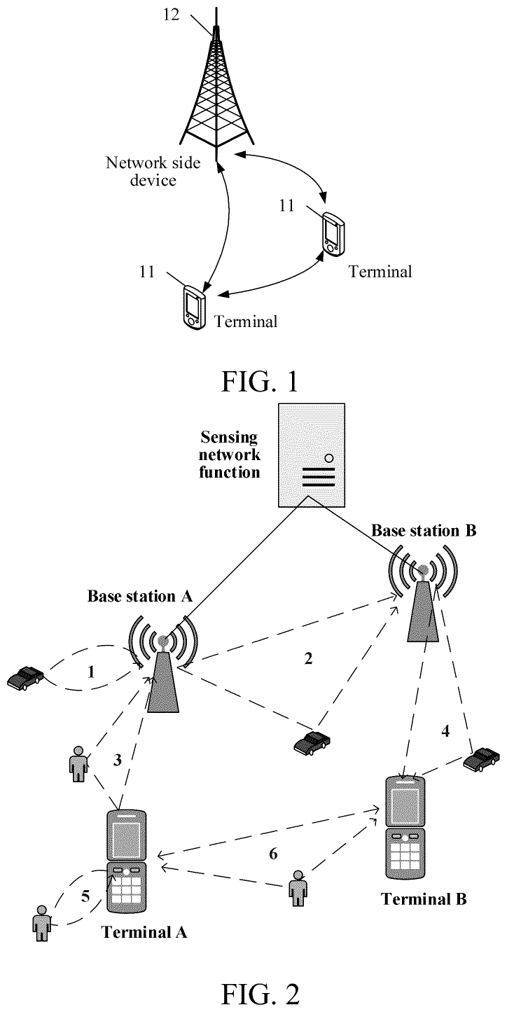

FIG. 1 is a block diagram of a wireless communication system to which the embodiments of this application are applicable. The wireless communication system includes a terminal 11 and a network side device 12. The terminal 11 may be a terminal side device such as a mobile phone, a tablet personal computer (Tablet Personal Computer), a laptop computer (Laptop Computer) or a notebook computer, a personal digital assistant (Personal Digital Assistant, PDA), a palmtop computer, a netbook, an ultra-mobile personal computer (ultra-mobile personal computer, UMPC), a mobile Internet device (Mobile Internet Device, MID), an augmented reality (augmented reality, AR)/virtual reality (virtual reality, VR) device, a robot, a wearable device (Wearable Device), vehicle user equipment (Vehicle User Equipment, VUE), pedestrian user equipment (Pedestrian User Equipment, PUE), smart household (household devices with wireless communication functions, such as a refrigerator, a television, a washing machine, or furniture), a game console, a personal computer (personal computer, PC), a teller machine, or a self-service machine, and the wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, and the like. It should be noted that, a specific type of the terminal 11 is not limited in the embodiments of this application. The network side device 12 may include an access network device or a core network device. The access network device may also be referred to as a radio access network device, a radio access network (Radio Access Network, RAN), a radio access network function, or a radio access network unit. The access network device may include a base station, a wireless local area network (Wireless Local Area Network, WLAN) access node, a WiFi node, or the like. The base station may be referred to as a NodeB, an evolved NodeB (eNB), an access point, a base transceiver station (Base Transceiver Station, BTS), a radio base station, a radio transceiver, a basic service set (Basic Service Set, BSS), an extended service set (Extended Service Set, ESS), a home NodeB, a home evolved NodeB, a transmission reception point (Transmission Reception Point, TRP), or another appropriate term in the art. As long as a same technical effect is achieved, the base station is not limited to a specified technical term. It should be noted that, in the embodiments of this application, only a base station in an NR system is used as an example, but a specific type of the base station is not limited. The core network device may include but is not limited to at least one of the following: a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rules function (Policy and Charging Rules Function, PCRF) unit, an edge application server discovery function (Edge Application Server Discovery Function, EASDF), unified data management (Unified Data Management, UDM), unified data repository (Unified Data Repository, UDR), a home subscriber server (Home Subscriber Server, HSS), a centralized network configuration (Centralized network configuration, CNC), a network repository function (Network Repository Function, NRF), a network exposure function (Network Exposure Function, NEF), a local NEF (Local NEF or L-NEF), a binding support function (Binding Support Function, BSF), or an application function (Application Function, AF). It should be noted that, in the embodiments of this application, the core network device in the NR system is merely used as an example for description, but a specific type of the core network device is not limited.

To facilitate understanding, some content involved in the embodiments of this application are described below.

### 1. Integrated Sensing and Communication/Integrated Sensing-Communication

Wireless communication and radar sensing (Communication&Sensing, C&S) have been developing in parallel, but an intersection of the wireless communication and the radar sensing is limited. They have a lot in common in terms of signal processing algorithms, devices, and system architectures to a certain extent. In recent years, a traditional radar is developing towards a more universal direction of wireless sensing. Wireless sensing may extensively refer to retrieving information from received radio signals. For wireless sensing related to sensing a target location, a dynamical parameter such as a reflection delay, an angle of arrival, an angle of departure, or Doppler of a target signal may be estimated in a common signal processing method. Sensing a target physical feature may be implemented by measuring an inherent signal mode of a device/object/activity. The two sensing manners may respectively be referred to as sensing parameter estimation and mode recognition. In this sense, wireless sensing refers to a more universal sensing technology and application using radio signals.

Integrated sensing and communication (Integrated Sensing and Communication, ISAC) has a potential to integrate wireless sensing into large-scale mobile network, which is referred to as perceptive mobile networks (Perceptive Mobile Networks, PMNs). For details, refer to literature [1]: Rahman, Md Lushanur, et al. “Enabling joint communication and radio sensing in mobile networks-a survey.” arXiv preprint arXiv: 2006.07559 (2020). Details are not described herein again.

The perceptive mobile networks are capable of providing both communication and wireless sensing services, and have the potential to become a ubiquitous wireless sensing solution due to its large broadband coverage and robust infrastructure. The perceptive mobile networks may be widely applied to communication and sensing in transportation, communication, energy, precision agriculture, and security fields. The perceptive mobile network may alternatively provide a complementary sensing capacity for an existing sensor network, has a unique day-night operation function, and can penetrate through fog, leaves, and even solid subjects. Some common sensing services are shown in Table 1 below:

TABLE 1

| | Real-time | | |
|---|---|---|---|
| Physical | performance | | |
| range of | requirement | | |
| sensing | of sensing | Sensing functions | Application purposes |
| Wide | Medium | Weather, air quality, | Meteorology, |
| | | and the like | agriculture, and living |
| | | | services |
| Wide | Medium | Vehicle flow (road) | Smart city, intelligent |
| | | and pedestrian flow | transportation, and |
| | | (metro station) | commercial service |
| Wide | Medium | Animal movement, | Animal husbandry, |
| | | migration, and the like | ecological |
| | | | environmental |
| | | | protection, and the like |
| Wide | High | Target tracing, | Many application |
| | | distance | scenarios of |
| | | measurement, | conventional radar, |
| | | velocity | vehicle to everything |
| | | measurement, and | (vehicle to everything, |
| | | angle measurement | V2X), and the like |
| Wide | Low | Three-dimensional | Navigation and smart |
| | | map construction | city |
| Small | High | Action posture | Intelligent interaction of |
| | | recognition | smartphones, games, |
| | | | and smart household |
| Small | High | Heartbeat/respiration | Health supervision and |
| | | and the like | medical treatment |
| Small | Medium | Imaging | Security check and |
| | | | logistics |
| Small | Low | Materials | Construction, |
| | | | manufacturing, |
| | | | exploration, and the like |

As shown in FIG. 2, based on different transmitting nodes and receiving nodes of a sensing signal, there are six sensing manners as follows.

Manner 1: Base station echo sensing. In this sensing manner, base station A sends a sensing signal and performs sensing measurement by receiving echo of the sensing signal.

Manner 2: Air interface sensing between base stations. Base station B receives a sensing signal sent by base station A and performs sensing measurement.

Manner 3: Uplink air interface sensing. In this case, base station A receives a sensing signal sent by terminal A and performs sensing measurement.

Manner 4: Downlink air interface sensing. In this case, terminal B receives a sensing signal sent by base station B and performs sensing measurement.

Manner 5: Terminal echo sensing. Terminal A sends a sensing signal and performs sensing measurement by receiving echo of the sensing signal.

Manner 6: Sidelink (Sidelink) sensing between terminals. In this case, terminal B receives a sensing signal sent by terminal A and performs sensing measurement.

It should be noted that, each sensing manner in FIG. 2 takes one sensing signal transmitting node and one sensing signal receiving node as examples. In actual systems, one or more different sensing manners may be selected according to different sensing use cases and needs, and each sensing manner may have one or more transmitting nodes and receiving nodes.

### 2. Non-Ideal Factors of Sensing

During integrated sensing and communication, it is particularly important to obtain accurate measurement information, and non-ideal factors of a device and a hardware circuit of a node participating in a sensing service may significantly affect measurement accuracy. For example, in a sensing manner of performing sending and receiving between a base station and a terminal, extracting channel state information (Channel State Information, CSI) for sensing is one of main implementations of integrated sensing and communication. In this process, obtaining channel information of relatively good quality is particularly important, and some non-ideal factors may cause errors in CSI measurement, thereby significantly affecting sensing accuracy.

For example, literature [2]: Zhuo, Y., Zhu, H., Xue, H., & Chang, S. (2017 May). Perceiving accurate CSI phases with commodity WiFi devices. In IEEE INFOCOM 2017—IEEE Conference on Computer Communications (pp. 1-9). Analyzed by IEEE, impact of a receiving node on CSI may include:

(1) Power amplifier uncertainty (Power Amplifier Uncertainty, PAU), or uncertainty of a signal receiving power. Because a device such as a low noise amplifier (Low Noise Amplifier, LNA) or a programmable gain amplifier (Programmable Gain Amplifier, PGA) is non-ideal, actual gain adjustment is inconsistent with expectation, and therefore, a CSI amplitude obtained through measurement is inaccurate.

(2) An inphase (Inphase, I) branch is imbalanced with a quadrature (quadrature, Q) branch. Limitations of performance of devices in the I and Q branches lead to that phases of local oscillator signals cannot be strictly 90° different, gains of signals in the two branches are different, and there is a direct current offset. This further leads to violation of orthogonality of the baseband signal, resulting in deterioration of the CSI.

(3) Time-frequency synchronization deviation. Factors such as a clock deviation and non-ideal synchronization between the transmitting node and the receiving node cause problems such as a carrier frequency offset (Carrier Frequency Offset), a sampling frequency offset (Sampling Frequency Offset), and a symbol timing offset (Symbol Timing Offset), and may affect accuracy of velocity estimation or cause fuzzy ranging. Literature [3]: Zhang, J. A., Wu, K., Huang, X., Guo, Y. J., Zhang, D., & Heath Jr, R. W. (2022). Integration of Radar Sensing into Communications with Asynchronous Transceivers. The author of arXiv preprint arXiv: 2203.16043. summarizes methods such as sharing a reference clock, cross-correlation of a plurality of antennas in a single station, and joint elimination of timing errors in a plurality of stations. It is also expounded that the impact of clock deviation on sensing may be addressed by improving a GPS clock, relaxing sensing requirements of a single node, associating multi-node measurement with a target, and the like.

(4) Antenna/array amplitude phase error. When sensing is performed through beam forming, a beam forming amplitude and phase error may cause a formed beam shape (a beam gain, a beam width, and a side lobes level) to be inconsistent with reality, and further cause accuracy to be reduced when sensing is performed based on channel information obtained after beam forming, resulting in estimation errors of an angle and reflected power. In addition, a beam switching delay may also increase impact of interference and noise on a sensing result. For example, literature [4]: Tadayon, N., Rahman, M. T., Han, S., Valaee, S., & Yu, W. (2019). Decimeter ranging with channel state information. IEEE Transactions on Wireless Communications, 18(7), 3453-3468. An impact of a transmit end on the CSI is summarized, and mainly includes windowing, precoding, beamforming, and other unknowable processing to the receive end, which leads to the receive end being unable to obtain real channel information.

(5) Time-domain random phase. The random phase is from a state of at least one of a transmitter antenna, a radio frequency module (including various devices connected to a radio frequency channel), a digital processing module, or a clock module that changes (for example, being turned on, turned off, or converted from one state to another state) in a signal sending and receiving process. If a device has more than one transmitter, each transmitter may generate an independent random phase. If each transmitter is connected to at least one antenna, antennas/antenna sub-arrays connected to different transmitter have different random phases. The random phases are generally consistent in a transmit signal bandwidth, but random phase values generated at different moments are different, and are randomly distributed within a radian range.

It can be learned from the above that in the related technology, an example in which a transmit end of a sensing signal is UE, and a receive end is a base station is used. When channel estimation is performed based on a reference signal (for example, an SRS), phases of uplink channel estimation at a base station side are discontinuous in time, that is, there is a random phase offset of channel estimation at different uplink moments. If UE has more than one radio frequency channel, different random phases are introduced to different radio frequency channels. The random phase almost does not affect communication performance, but may introduce an uplink sensing error, and even a sensing service cannot be performed.

The random phase almost does not affect communication performance, but may introduce an uplink sensing error, leading to poor sensing performance. Embodiments of this application provide a sensing method and apparatus, and a device. Random phase measurement is performed in a process of a sensing service or an integrated sensing and communication service, and a sensing-related operation is performed based on a random phase measurement result. This may improve sensing performance.

In the embodiments of this application, a first device receives a first signal sent by a second device, where the first signal is used for random phase measurement of an antenna port of the second device, the second device is a terminal, and the second device is a transmitting node of a signal related to a sensing service or an integrated sensing and communication service; the first device performs random phase measurement based on the first signal, to obtain a first random phase measurement result; and the first device performs a first operation, where the first operation includes at least one of the following: sending the first random phase measurement result to the second device or a third device, the first device being a network side device, the third device being a terminal, and the third device being a receiving node of the signal related to the sensing service or the integrated sensing and communication service; or performing a sensing-related operation based on the first random phase measurement result. That is, in the embodiments of this application, random phase measurement is performed in a process of the sensing service or the integrated sensing and communication service, and the sensing-related operation is performed based on the random phase measurement result. In this way, impact of the random phase on the measurement value of the sensing measurement quantity may be reduced, thereby improving sensing performance.

Based on this, in the sensing method provided in the embodiments of this application, random phase measurement is performed in a case that a sensing service or an integrated sensing and communication service is performed, and a sensing-related operation is performed based on a random phase measurement result, to reduce impact of the random phase on the sensing result. For convenience of understanding, some principles of random phase measurement and random phase calibration involved in the embodiments of this application are described below.

(1) CSI quotient/CSI conjugate product-based random phase calibration principle:

A sensing signal transmitter or a sensing signal receiver has a plurality of antennas. Because the plurality of antennas usually use a same clock source, calibration of a channel delay and Doppler may be implemented by using a method of a CSI quotient or a CSI conjugate product, to eliminate an error introduced by a frequency offset or a random phase to the plurality of antennas. For explanations and descriptions of the CSI quotient, refer to literature [5]: Zeng, Youwei, et al. “FarSense: Pushing the range limit of WiFi-based respiration sensing with CSI ratio of two antennas.” Proceedings of the ACM on Interactive, Mobile, Wearable and Ubiquitous Technologies 3.3 (2019): 1-26.

The method is simple to implement and has a small calculation amount. However, at least one of the transmitter or the receiver is required to have a plurality of antennas, and non-ideal factors (a frequency offset or a random phase) introduced to measurement values of sensing measurement quantity obtained by the antennas are the same.

For example, channel estimation of antenna 1 of a sensing signal receiver is H₁′(f,t)=H₁(f,t)e^{jφ}, where H₁(f,t) is real CSI of antenna 1, and φ is a phase difference introduced by a non-ideal factor. Similarly, channel estimation of antenna 2 is H₂′(f,t)=H₂(f,t)e^{jφ}, and H₂(f,t) is real CSI of antenna 2. The CSI quotient may be expressed as the following formula:

$${H}_{ratio}^{12} ( f , t ) = \frac{{H}_{1} ( f , t ) {e}^{j φ}}{{H}_{2} ( f , t ) {e}^{j φ}} = \frac{{H}_{1} ( f , t )}{{H}_{2} ( f , t )}$$

In addition, the CSI conjugate product may be expressed as the following formula:

$${H}_{p r o d u c t}^{12} ( f , t ) = {H}_{1} ( f , t ) {e}^{j φ} \cdot {H}_{2}^{*} ( f , t ) {e}^{- j φ} = {H}_{1} ( f , t ) \cdot {H}_{2}^{*} ( f , t )$$

It can be learned from the above that, by using the CSI quotient or the CSI conjugate product, the phase difference introduced by the non-ideal factor in the channel estimation is eliminated. In the embodiments of this application, a measurement value of a sensing measurement quantity may be extracted based on Hᵣₐₜᵢₒ¹²(f,t) or H_{product}¹²(f,t) in which the phase difference is eliminated, to achieve random phase calibration on the measurement value of the sensing measurement quantity. Details are not described herein again.

### (2) Reference Path-Based Random Phase Calibration Principle:

It is assumed that a transmit baseband signal is s₀(t), a carrier frequency is f_{c}, and a transmit signal is s(t)=s₀(t)e^{j/2πf}^{_{c}}^{t}. In addition, it is assumed that a radio channel between a transmitter and a receiver is

$$H ( f , t ) = {\sum }_{l = 1}^{L} {a}_{l} ( t ) {e}^{- j 2 π f {τ}_{l}} {e}^{j 2 π {f}_{d , l} t} ,$$

where L is a total quantity of multipaths in the channel, τₗ is a delay of a 1^{st} multipath, and f_{d,l} is a Doppler frequency of the 1^{st} multipath. Ideally, after the transmit signal passes through the channel, a signal received by an antenna of the receiver is

$$r ( t ) = {s}_{0} ( t ) {e}^{j 2 π {f}_{c} t} \cdot {\sum }_{l = 1}^{L} {a}_{l} ( t ) {e}^{- j 2 π {f}_{c} {τ}_{l}} {e}^{j 2 π {f}_{d , l} t} .$$

For a sensing receiver, a signal s₀(t) and a carrier frequency f_{c} are known. H(f,t) may be obtained based on the received signal r(t), that is, a CSI matrix including sensing information is obtained. Further, the sensing measurement quantity may further be obtained by using a parameter estimation algorithm such as Fast Fourier Transform (Fast Fourier Transform, FFT) or multiple signal classification (MUltiple SIgnal Classification, MUSIC), for example, τₗ, f_{d,l}, and the like. For a communication receiver, based on a known carrier frequency f_{c}, the received signal is down-converted, and channel estimation is completed to obtain CSI, so that a baseband transmit signal s₀(t) may be obtained.

However, due to introduction of the random phase, the transmit signal changes to s(t)=s₀(t)e^{j2πf}^{_{c}}^{t}e^{jφ(t)}, where φ(t) is a random phase.

For the sensing receiver, an antenna receives a signal may be expressed as the following formula:

$$\begin{matrix}r ( t ) = {s}_{0} ( t ) {e}^{j 2 π {f}_{c} t} {e}^{j φ ( t )} \cdot {\sum }_{l = 1}^{L} {a}_{l} ( t ) {e}^{- j 2 π {f}_{c} {τ}_{l}} {e}^{j 2 π {f}_{d , l} t} , \\ = {s}_{0} ( t ) {e}^{j 2 π {f}_{c} t} \cdot {\sum }_{l = 1}^{L} {a}_{l} ( t ) {e}^{- j 2 π {f}_{c} {τ}_{l}} {e}^{j 2 π {f}_{d , l} t} {e}^{j φ ( t )}\end{matrix} , \qquad ( 1 )$$

After down-conversion, obtained channel estimation with random phase deflection is:

$$\begin{matrix}{H}^{′} ( f , t ) = {\sum }_{l = 1}^{L} {a}_{l} ( t ) {e}^{- j 2 π {f}_{c} {τ}_{l}} {e}^{j 2 π {f}_{d , l} t} {e}^{j φ ( t )} , \\ = {\sum }_{l = 1}^{L} {a}_{l} ( t ) {e}^{- j 2 π {f}_{c} {τ}_{l}} {e}^{j 2 π {f}_{d , l}^{′} t}\end{matrix} , \qquad ( 2 )$$

When a random phase φ(t) introduced at each sampling moment t is different from each other, that is, φ(tⱼ)−φ(tᵢ)≠0, i<j, without considering interference and noise, a Doppler frequency obtained based on adjacent two times of channel estimation may be expressed as the following formula:

$${f}_{d , l}^{′} ( t ) = {f}_{d , l} + Δ f ( t ) = {f}_{d , l} + \frac{φ ( {t}_{j} ) - φ ( {t}_{i} )}{{t}_{j} - {t}_{i}} \neq {f}_{d , l} \qquad ( 3 )$$

Based on a plurality of times of sampling, many false Doppler frequency components different from each other are obtained by using a parameter estimation algorithm such as FFT or MUSIC. Consequently, true Doppler cannot be accurately estimated.

It should be noted that because the random phase may act on all multipaths of the CSI, and introduced random phase values are the same for all the multipaths (refer to equations (1) and (2)). An optional calibration method process is as follows. It is assumed that based on sensing prior information, a true delay value of any 1^{st} multipath is known as τₗ′ (which is usually a line of sight (Line Of Sight, LOS) path, and may also be any non line-of-sight (Non Line-Of-Sight, NLOS) path in some cases), for example, an NLOS reflection path of a sensing reference node (such as a reconfigurable intelligent surface (Reconfigurable Intelligent Surface, RIS) or a backscatter (Backscatter, BSC)) is known. A delay of the 1^{st} multipath obtained through measurement is τₗ′. It is assumed herein that due to another non-ideal factor, Δτ=τₗ′−τₗ, first, delay calibration is performed on all multipaths of the CSI matrix, that is:

$$\begin{matrix}{H}_{1} ( f , t ) = {e}^{j 2 π {f}_{c} [ {τ}_{l}^{′} - {τ}_{l} ]} \cdot {\sum }_{l = 1}^{L} {a}_{l} ( t ) {e}^{- j 2 π {f}_{c} {τ}_{l}^{′} ( t )} {e}^{j 2 π {f}_{d , l}^{′} t} \\ = {\sum }_{l = 1}^{L} {a}_{l} ( t ) {e}^{- j 2 π {f}_{c} {τ}_{l}} {e}^{j 2 π {f}_{d , l}^{′} t}\end{matrix} \qquad ( 4 )$$

On the other hand, it is assumed that a true Doppler frequency value of any 1^{st} multipath in a time period T is known as f_{d,l} (which is usually also an LOS path, and may be any NLOS path in some cases). Based on a CSI matrix on which delay calibration is performed, delay calibration is performed. First, a multipath complex amplitude (including Doppler) with a known delay of τₗ needs to be extracted based on the CSI matrix, and the following formula is obtained through maximum likelihood estimation:

$$\begin{matrix}{H}_{{τ}_{l}} ( f , t ) = {e}^{j 2 π {f}_{c} {τ}_{l}} \cdot {H}_{1} ( f , t ) \\ = {e}^{j 2 π {f}_{c} {τ}_{l}} \cdot {\sum }_{l = 1}^{L} {a}_{l} ( t ) {e}^{- j 2 π {f}_{c} {τ}_{l}} {e}^{j 2 π {f}_{d , l}^{′} t} \\ = {a}_{l} ( t ) {e}^{j 2 π {f}_{d , l}^{′} t} + {\sum }_{k = 1 , k \neq l}^{L} {a}_{k} ( t ) {e}^{- j 2 π {f}_{c} ( {τ}_{k} - {τ}_{l} )} {e}^{j 2 π {f}_{d , l}^{′} t} \\ \approx {a}_{l} ( t ) {e}^{j 2 π {f}_{d , l}^{′} t}\end{matrix} \qquad ( 5 )$$

Doppler of the path is calibrated, and calibrated CSI at moment tₛ in the time period T may be obtained (where tₛ is a time difference relative to a reference moment), that is:

$$\begin{matrix}{H}_{c} ( f , {t}_{s} ) = {e}^{j 2 πΔ {f}_{d , l} {t}_{s}} \cdot {H}_{1} ( f , t ) \\ = {e}^{j 2 π ( {f}_{d , l} - {f}_{d , l}^{′} ) {t}_{s}} \cdot {e}^{j 2 π {f}_{c} ( {τ}_{l}^{′} - {τ}_{l} )} \cdot {\sum }_{l = 1}^{L} {a}_{l} ( {t}_{s} ) {e}^{- j 2 π {f}_{c} {τ}_{l}^{′} ( t )} {e}^{j 2 π {f}_{d , l}^{′} {t}_{s}} \\ = {\sum }_{l = 1}^{L} {a}_{l} ( {t}_{s} ) {e}^{- j 2 π {f}_{c} {τ}_{l}} {e}^{j 2 π {f}_{d , l} {t}_{x}}\end{matrix} \qquad ( 6 )$$

where Δf_{d}=f_{d,l}−f_{d,l}′. In this case, an error of the sensing measurement quantities τₗ and f_{d,l} of the 1^{st} multipath is eliminated. Because an error caused by the random phase has a same effect on all multipaths, errors caused by all other multipaths due to a frequency offset can also be eliminated. It should be noted that, when the Doppler frequency is calibrated, because a value of the random error is different from each other during each sampling (being approximately uniformly and randomly distributed within a radian range), each CSI sample needs to be calibrated one by one based on the equation (6). In addition, generally, a true complex amplitude aₗ of the 1^{st} multipath within the time period T cannot be known. Therefore, during calibration, samples at different tₛ moments need to have one uniform reference moment (generally, may be selected as a sampling moment of a 1^{st} sample within the time period T), to determine a length of tₛ, and determine a phase calibration value of each CSI sample. In other words, the Doppler calibration is essentially calibration of relative phases among a plurality of consecutive CSI samples.

### (3) Method for Estimating Random Phases of Different Moments:

Based on (2) Reference path-based random phase calibration principle, a relatively practical method for estimating random phases of different moments is as follows.

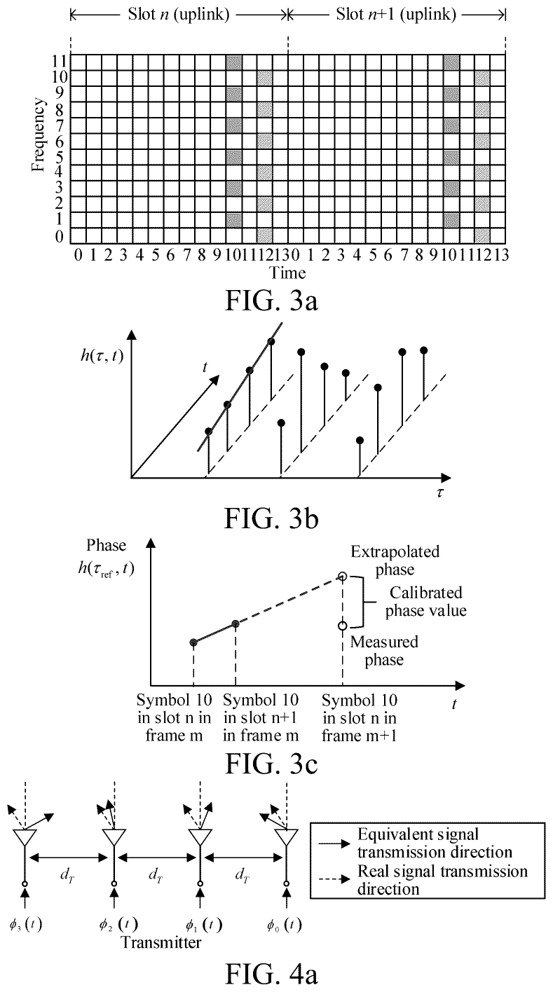

It is assumed that pilots (reference signals)/sensing signals used for random phase estimation are placed in at least two different uplink slots in a same uplink cycle, as shown in FIG. 3a. Generally, at least two uplink slots are required in one uplink cycle. For a device having a plurality of transmit radio frequency links, each radio frequency link needs to have at least two uplink slots. The receive end obtains channel estimation based on the pilots (reference signals)/sensing signals of the random phase estimation, and performs inverse fast Fourier transform (Inverse Fast Fourier Transform, IFFT) on the channel estimation in frequency domain, to obtain an impulse response of the channel. Impulse responses at different moments are correspondingly obtained for a plurality of uplink slots, as shown in FIG. 3b. An objective of the IFFT operation is to obtain parameters of a reference path (generally an LOS path or an NLOS path constructed by a reference node (RIS/BSC)) of a channel, for example, a delay, an amplitude, and a phase of the reference path.

Generally, there is no random phase deflection between different uplink slots in a same uplink cycle. It is assumed that different uplink slot interval times satisfy an approximately linear change of phases of a channel reference path, a reference path phase at an uplink slot moment in a next uplink cycle can be easily extrapolated based on phases of the channel reference path in at least two different uplink slots in the uplink cycle. However, after uplink and downlink switching, a random phase deflection (a random phase difference) is introduced to the reference path phase at the uplink slot moment in the next uplink cycle. As shown in FIG. 3c, a phase difference between an extrapolated phase and an actually measured phase of the reference path is a random phase value that needs to be estimated. The same operation is performed on different uplink slots, to obtain all random phase values. It should be noted that a slope of a folding line in FIG. 3c may be positive, negative, or 0 based on different Doppler values of actual reference paths. Corresponding random phase values are compensated in channel estimation/received signal of all different uplink slots, so that accurate measurement of Doppler of a target signal may be implemented.

### (4) Method for Estimating Random Phases of Different Antenna Ports:

Different radio frequency links have different random phases, and different antenna ports have a random phase difference. Consequently, there is an error in angle measurement. Based on (2) Reference path-based random phase calibration principle, a relatively practical method for estimating random phases of different antenna ports is as follows.

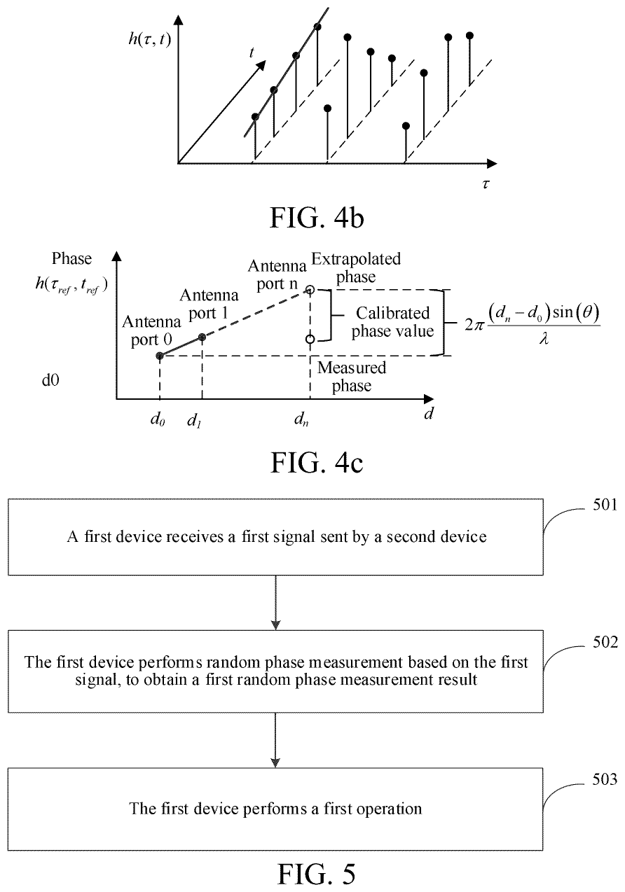

It is assumed that a transmitter has four antenna ports (four independent radio frequency links), and when a receive end performs signal angle-of-departure (an azimuth angle of departure is used as an example for description, and is denoted by θ) estimation based on transmit signals received from the four ports, a phase difference of the transmit signals from the ports needs to be obtained. However, due to an impact of the random phase of each port, seen from a receiver side, signal transmission directions of the antenna ports are different (that is, “equivalent signal transmission directions” in FIG. 4a).

First, the receive end obtains channel estimation of a plurality of transmit antenna ports based on the pilots (reference signals)/sensing signals for random phase estimation, and performs IFFT on channel estimation of each port in frequency domain, to obtain an impulse response of the channel, as shown in FIG. 4b. An objective of the IFFT operation is to obtain parameters of a reference path (generally an LOS path or an NLOS path constructed by a reference node (RIS/BSC)) of a channel, for example, a delay, an amplitude, and a phase of the reference path.

It is assumed that the transmitter array is a linear array (the same goes for other arrays), and a reference path phase ϕ₀(t) of antenna port 0 is a reference phase. In addition, it is assumed that an angle of departure of the reference path is known as θ. As a result, a reference path phase of antenna port n is

$${ϕ}_{n}^{′} ( t ) = {ϕ}_{0} ( t ) + 2 π \frac{( {d}_{n} - {d}_{0} ) sin ( θ )}{λ} ,$$

where d₀, dₙ are distances separately from antenna port 0 and antenna port n to an antenna array reference location, and λ is a signal wave length, as shown in FIG. 4c. An actual reference path phase of antenna port n is ϕₙ(t), therefore, a random phase value that antenna port n needs for calibration is Δϕₙ=ϕₙ(t)−ϕₙ′(t). It should be noted that a slope of a folding line in FIG. 4c may be positive, negative, or 0 based on different angle values of actual reference paths. The foregoing operation is performed on antenna ports 1, 2, . . . , and n in turn, and random phase values that all antenna ports need for calibration may be obtained. Corresponding random phase values are compensated in channel estimation/received signal of all antenna ports, so that accurate measurement of an angle of a target signal may be implemented.

It should be noted that the sensing method provided in the embodiments of this application is not only applicable to measurement, estimation, and calibration of a random phase of at least one antenna port of the second device at different uplink moments, but also applicable to measurement, estimation, and calibration of a random phase of at least two different antenna ports of the second device. It should be understood that the random phase measurement, estimation, and calibration operations may achieve at least one of the following two effects.

(1) Eliminate random phases of at least one antenna port of the second device at different uplink moments, or eliminate random phases of at least two different antenna ports of the second device, to further eliminate impact of the random phase on Doppler measurement and/or angle measurement.

(2) Use a channel reference path phase of an antenna port at an uplink moment as a reference phase, so that other antenna ports and/or channel reference path phases of the antenna port at other uplink moments keep continuity/consistency with the reference phase, thereby eliminating impact of the random phase on Doppler measurement and/or angle measurement.

Based on the foregoing description, it should be understood that the concept of “random phase” in the embodiments of this application also includes a difference between random phases. When the embodiments of this application are used for performing measurement, estimation, and calibration on random phases of at least one antenna port of the second device at different uplink moments, impact of the random phase on Doppler measurement can be eliminated. When the embodiments of this application are used for performing measurement, estimation, and calibration on random phases of at least two different antenna ports of the second device, impact of the random phase on angle (including an azimuth angle and an elevation angle) measurement can be eliminated.

For a method for estimating random phases of at least one antenna port of a second device at different uplink moments, refer to (2) Reference path-based random phase calibration principle and (3) Method for estimating random phases of different moments; and For a method for estimating random phases of at least two different antenna ports of a second device, refer to (2) Reference path-based random phase calibration principle and (4) Method for estimating random phases of different antenna ports.

### (5) Antenna Switching:

Chapter 6.2.1.2 in 3GPP TS 38.214 provides a detailed explanation of antenna switching (also referred to as antenna switching, Antenna Switching) of an uplink sounding reference signal (Sounding Reference Signal, SRS). In consideration of antenna costs and an uplink rate requirement of a terminal, generally, a quantity of transmit antennas of UE is less than that of receive antennas. In addition, due to a limited transmission capability of the UE, even if sufficient receive-end antennas can be used, the SRS cannot be sent on all receive-end antennas at a time. Therefore, the SRS needs to be sent on all receive antenna ports in a manner of antenna switching. When usage in a high layer parameter SRS-ResourceSet set of the UE is configured as “antennaSwitching”, antenna switching capability information of the UE may be configured by using a parameter supportedSRS-TxPortSwitch, and content of supportedSRS-TxPortSwitch may be one of the following: ‘t1r2’ for 1T2R, ‘t1r1-t1r2’ for 1T=1R/1T2R, ‘t2r4’ for 2T4R, ‘t1r4’ for 1T4R, ‘t1r6’ for 1T6R, ‘1t8r’ for 1T8R, ‘2t6r’ for 2T6R, ‘2t8r’ for 2T8R, ‘4t8r’ for 4T8R, ‘t1r1−t1r2−t1r4’ for 1T=1R/1T2R/1T4R, ‘t1r4−t2r4’ for 1T4R/2T4R, ‘t1r1−t1r2−t2r2−t2r4’ for 1T=1R/1T2R/2T=2R/2T4R, ‘t1r1−t1r2−t2r2−t1r4−t2r4’ for 1T=1R/1T2R/2T=2R/1T4R/2T4R, ‘t1r1’ for 1T=1R, ‘t2r2’ for 2T=2R, ‘t1r1−t2r2’ for 1T=1R/2T=2R, ‘t4r4’ for 4T=4R, or ‘t1r1−t2r2−t4r4’ for 1T=1R/2T=2R/4T=4R.

It is assumed that the UE has m transmit antennas and n receive antennas, where m<n. In this case, when using the receive antennas to send the SRS, the UE can simultaneously send the SRS resources on only m receive antennas at most, and it takes a total of n/m times to send all the SRS resources on all the receive antennas in the antenna switching manner. For example, for ‘t2r4’ for 2T4R, one UE may be configured with at most two SRS resource set resources, and each SRS resource set may be configured with two SRS resources transmitted on different OFDM symbols. Each SRS resource corresponds to two SRS ports, and UE antenna ports associated with two SRS ports for a 2^{nd} SRS resource in each SRS resource set are different from UE antenna ports associated with two SRS ports for a 1^{st} SRS resource in the SRS resource set.

For more explanations of options (namely, 1T1R/1T2R/1T4R/1T6R/1T8R/2T2R/2T4R/2T6R/2T8R/4T4R/4T8R) in the UE antenna switching capability supportedSRS-TxPortSwitch, refer to: Chapter 6.2.1.2 of “3GPP TS 38.214 V17.0.0 Physical layer procedures for data”.

The following describes in detail the sensing method provided in the embodiments of this application through some embodiments and application scenarios thereof with reference to the accompanying drawings.

Refer to FIG. 5, FIG. 5 is a flowchart of a sensing method according to an embodiment of this application. The method may be performed by a first device. As shown in FIG. 5, the method includes the following steps.

Step 501: A first device receives a first signal sent by a second device, where the first signal is used for random phase measurement of an antenna port of the second device, the second device is a terminal, and the second device is a transmitting node of a signal related to a sensing service or an integrated sensing and communication service.

Step 502: The first device performs random phase measurement based on the first signal, to obtain a first random phase measurement result.

Step 503: The first device performs a first operation, where the first operation includes at least one of the following:
sending the first random phase measurement result to the second device or a third device, the first device being a network side device, the third device being a terminal, and the third device being a receiving node of the signal related to the sensing service or the integrated sensing and communication service; or
performing a sensing-related operation based on the first random phase measurement result.

In this embodiment, the first device may be a terminal or a network side device, and the second device is a terminal. For example, for sensing between a base station and UE, the first device may be a base station, and the second device may be UE; for sensing in which UE 1 sends a sensing signal, and UE 2 receives the sensing signal, the first device may be UE 2 or a base station, and the second device may be UE 1; and for echo sensing of UE, the first device may be a base station, and the second device may be UE.

The first signal is used for random phase measurement. In this way, a receive end (that is, the first device) of the first signal may perform random phase measurement based on the first signal, to obtain the first random phase measurement result. The first random phase measurement result may include but is not limited to at least one of the following: a random phase value of at least one antenna port of the second device in at least one uplink moment, a difference between a random phase value of at least one antenna port of the second device and a random phase value of a first reference port, a difference between a random phase value of at least one antenna port of the second device in at least one uplink moment and a random phase value of a reference moment, indication information of at least two antenna ports that are of antenna ports of the second device and that have a same random phase, indication information of at least two antenna ports that are of antenna ports of the second device and that have different random phases, or the like.

The different uplink moments may be in different time units, and the time unit may be properly set based on a change of the random phase. Specifically, the time unit may satisfy: random phases of the first signal sent in slots of a same time unit are the same. It should be noted that, random phases of the first signal sent in different time units may be different. For example, the time unit may be an uplink cycle.

It should be noted that, effects of this embodiment on the random phase measurement of the antenna port of the second device at least include the following items.

i. Obtain or perfect random phase information (including a random phase value) of the antenna port of the second device. The first device (including a receive end of the sensing signal and a computing node of a measurement value of a sensing measurement quantity) calibrates a result based on the random phase information (including the random phase value), to eliminate impact of the random phase on the measurement value of the sensing measurement quantity/sensing result.

ii. The random phase information further includes information indicating antenna ports with same/different random phases, so that the first device (including a receive end of the sensing signal and a computing node of a measurement value of a sensing measurement quantity) determines a transmit antenna port of the second device in combination with a sensing demand/sensing quality of service (Quality of Service, QoS) related to multi input multi output (Multi Input Multi Output, MIMO) sensing, to finally obtain an accurate measurement value of a MIMO/multi-port sensing measurement quantity.

For example, in a case that the first random phase measurement result includes indication information of at least two antenna ports with a same random phase in the second device, the second device may send, based on the at least two antenna ports with the same random phase, a second signal used for a sensing service or an integrated sensing and communication service. In this way, a receive end of the second signal may obtain a CSI quotient or a CSI conjugate product based on the second signal, and further obtain a measurement value of a sensing measurement quantity based on the CSI quotient or the CSI conjugate product; or may obtain a second random phase measurement result based on the second signal, calibrate, based on the second random phase measurement result, CSI obtained based on second signal estimation, and obtain a measurement value of a sensing measurement quantity based on the calibrated CSI. This may reduce the impact of the random phase on the sensing result.

The second signal or the first signal that may be used for sensing may be a signal that does not include transmission information, for example, existing LTE/NR synchronization and reference signals, including a synchronization signal and physical broadcast channel (Synchronization Signal and PBCH block, SSB) signal, a channel state information-reference signal (Channel State Information-Reference Signal, CSI-RS), a demodulation reference signal (Demodulation Reference Signal, DMRS), a sounding reference signal (Sounding Reference Signal, SRS), a positioning reference signal (Positioning Reference Signal, PRS), a phase tracking reference signal (Phase Tracking Reference Signal, PTRS), and the like; or may be a continuous wave (Continuous Wave, CW), a frequency modulated continuous wave (Frequency Modulated CW, FMCW), an ultra-wideband Gaussian pulse, and the like commonly used for a radar; and may alternatively be a newly designed dedicated signal, which has good correlation property and a low peak to average power ratio, or a newly designed integrated communication and sensing signal, which bears some information and has good sensing performance. For example, the new signal is at least one dedicated sensing signal/reference signal and at least one communication signal that is spliced/combined/superposed in time domain and/or frequency domain.

The following uses examples for description with reference to specific scenarios.

Scenario 1: For sensing between a base station and UE, in a case of obtaining a first random phase measurement result based on a first signal, the base station may perform a sensing operation based on the first random phase measurement result, for example, may send second configuration information to the UE based on the first random phase measurement result. The second configuration information is used by the UE to send a second signal, where the second signal is a signal related to a sensing service or an integrated sensing and communication service. Further, the UE may send the second signal based on the second configuration information. The base station receives the second signal, obtains a CSI quotient or a CSI conjugate product based on the second signal, and further obtains a measurement value of a sensing measurement quantity based on the CSI quotient or the CSI conjugate product. Alternatively, the base station may determine a second random phase measurement result based on the second signal, and may obtain the measurement value of the sensing measurement quantity based on the second random phase measurement result and the second signal.

Scenario 2: For sensing in which UE 1 sends a sensing signal and UE 2 receives the sensing signal, if the first device is a base station, the base station may send the first random phase measurement result to UE 1 or UE 2 in a case of obtaining the first random phase measurement result based on the first signal. An example in which UE 2 receives the first random phase measurement result is used. UE 2 may determine second configuration information based on the first random phase measurement result, and send the second configuration information to UE 1. UE 1 may send a second signal based on the second configuration information. Further, UE 2 may obtain a CSI quotient or a CSI conjugate product based on the second signal, and further obtain a measurement value of a sensing measurement quantity based on the CSI quotient or the CSI conjugate product. Alternatively, UE 2 may determine a second random phase measurement result based on the second signal, and may obtain the measurement value of the sensing measurement quantity based on the second random phase measurement result and the second signal.

Scenario 3: For echo sensing of UE, if the first device is a base station, the base station may send the first random phase measurement result to the UE in a case of obtaining the first random phase measurement result based on the first signal. The UE may determine second configuration information based on the first random phase measurement result, send a second signal based on the second configuration information, receive an echo signal of the second signal, further obtain a CSI quotient or a CSI conjugate product based on the echo signal of the second signal, and further obtain a measurement value of a sensing measurement quantity based on the CSI quotient or the CSI conjugate product. Alternatively, the UE may determine a second random phase measurement result based on the echo signal of the second signal, and may obtain the measurement value of the sensing measurement quantity based on the second random phase measurement result and the second signal.

According to the sensing manner provided in this embodiment of this application, a first device receives a first signal sent by a second device, where the first signal is used for random phase measurement of an antenna port of the second device, the second device is a terminal, and the second device is a transmitting node of a signal related to a sensing service or an integrated sensing and communication service; the first device performs random phase measurement based on the first signal, to obtain a first random phase measurement result; and the first device performs a first operation, where the first operation includes at least one of the following: sending the first random phase measurement result to the second device or a third device, the first device being a network side device, the third device being a terminal, and the third device being a receiving node of the signal related to the sensing service or the integrated sensing and communication service; or performing a sensing-related operation based on the first random phase measurement result. That is, in this embodiment of this application, random phase measurement is performed in a process of the sensing service or the integrated sensing and communication service, and the sensing-related operation is performed based on the random phase measurement result. In this way, impact of the random phase on the sensing result may be reduced, thereby improving accuracy of the sensing result.

In some optional embodiments, the first signal may further be used for sensing measurement. That is, a receive end (that is, the first device) of the first signal may perform sensing measurement based on the first signal, to obtain the measurement value of the sensing measurement quantity.

Optionally, at least one antenna port of the second device sends the first signal in at least two slots of at least one time unit, and random phases of the first signal sent in the same time unit are the same; or at least two antenna ports of the second device send the first signal in at least one slot of at least one time unit, and random phases of the first signal sent in the same time unit are the same.

In an implementation, at least one antenna port of the second device may send the first signal in at least two slots of at least one time unit, where random phases are the same between different slots in one time unit. An example in which the time unit is an uplink cycle is used, in an uplink cycle, a transmission state of an antenna port of a first node is not switched, that is, in the uplink cycle, the antenna port of the first node is not switched from an uplink state to a downlink state. Generally, it is considered that there is no random phase deflection between different uplink slots in an uplink cycle. It is assumed that different uplink slot interval times satisfy an approximately linear change of phases of a channel reference path, a reference path phase at an uplink slot moment in a next uplink cycle can be easily extrapolated based on phases of the channel reference path in at least two different slots in the uplink cycle, to implement random phase estimation of different uplink moments. For details, refer to the description in (3) Method for estimating random phases of different moments, and details are not described herein again. The different uplink moments may be located in different uplink cycles.

In another implementation, at least two antenna ports of the second device may send a first signal in at least one slot of at least one time unit. In this implementation, one of the at least two antenna ports may be used as a first reference port, to obtain a random phase difference between another of the at least two antenna ports and the first reference port. For a specific process, refer to the explanation and description in (4) Method for estimating random phases of different antenna ports, and details are not described herein again.

Further, at least two antenna ports of the second device may send a first signal in at least two slots of at least one time unit. In this way, not only random phase values of each of the at least two antenna ports at different uplink moments may be obtained, but also a random phase difference between at least one antenna port of the at least two antenna ports and the first reference port.

Optionally, the first random phase measurement result includes at least one of the following:
a random phase value of at least one antenna port of the second device;
a difference between a random phase value of at least one antenna port of the second device in at least one first uplink moment and a random phase value of a reference moment, the first uplink moment and the reference moment being different uplink moments in which the antenna port of the second device sends the first signal;
a difference between a random phase value of at least one antenna port of the second device and a random phase value of a first reference port, the first reference port being an antenna port of the second device;
indication information of at least two antenna ports that are of antenna ports of the second device and that have a same random phase; or
indication information of at least two antenna ports that are of antenna ports of the second device and that have different random phases.

The random phase value of the at least one antenna port of the second device may be, for example, a random phase value of at least one antenna port of the second device in at least one uplink moment. The at least one uplink moment is at least one uplink moment at which the second device sends the first signal.

As for the difference between a random phase value of at least one antenna port of the second device in at least one first uplink moment and the random phase value of a reference moment, the reference moment may be an uplink moment at which the second device first sends the first signal, the first uplink moment may be any uplink moment that is of uplink moments at which the second device sends the first signal and that is different from the reference moment, and the at least one first uplink moment may include an uplink moment among all uplink moments at which the second device sends the first signal other than the reference moment. For example, if port A of the second device sends the first signal in uplink slots of an n^{th} uplink cycle to an (n+K)^{th} uplink cycle, an uplink moment at which the first signal is sent in the n^{th} uplink cycle may be used as the reference moment, and a difference between a random phase value of the uplink moment at which the first signal is sent in an (n+1)^{th} uplink cycle to an (n+K)^{th} uplink cycle and a random phase value of the uplink moment at which the first signal is sent in the n^{th} uplink cycle may be separately calculated, where K is a positive integer.

As for a difference between a random phase value of at least one antenna port of the second device and a random phase value of the first reference port, for example, at least two antenna ports of the second device send the first signal, one of the at least two antenna ports may be used as the first reference port, and further, a difference between a random phase value of another antenna port (that is, an antenna port of the at least two antenna ports that send the first signal other than the first reference port) of the at least two ports and the random phase value of the first reference port may be calculated.

It should be noted that, in this embodiment, one uplink moment may correspond to one time unit, and different uplink moments may correspond to different time units. For example, the different uplink moments may be moments in different uplink cycles.

Optionally, before the first device receives a first signal sent by a second device, the method further includes at least one of the following:
the first device sends first configuration information to the second device;
the first device sends first configuration information to the third device; or
the first device sends first configuration information to a reference node of the sensing service or the integrated sensing and communication service, where
the first configuration information is used for random phase measurement of the antenna port of the second device.

For example, for sensing between a base station and UE, the base station may send first configuration information to the UE, and further, the UE may send a first signal based on the first configuration information; for sensing in which UE 1 sends a sensing signal and UE 2 receives the sensing signal, if the first device is a base station, the base station may send first configuration information to at least one of UE 1 or UE 2, and if the first device is UE 2, UE 2 may send the first configuration information to UE 1, and further, UE 1 may send a first signal based on the first configuration information; and for echo sensing of UE, a base station may send first configuration information to the UE, and further, the UE may send a first signal based on the first configuration information.

The reference node of the sensing service or the integrated sensing and communication service may include, but is not limited to, an RIS, a BSC, or another passive device or object for assisting in sensing. Optionally, in a case that the reference node is an RIS or a BSC, the first device or the second device may send the first configuration information to the reference node. In a case that the reference node is a passive object with a known state, the first device or the second device may not send the first configuration information to the reference node.

Optionally, the first configuration information includes at least one of the following:
a waveform type, a subcarrier spacing, a guard interval, a bandwidth, burst duration, a time domain interval, sending signal power, a signal format, a signal direction, a time resource, a frequency resource, a quasi co-location (Quasi co-location, QCL) relationship, antenna configuration information of the second device, or antenna configuration information of the third device.

The waveform type is, for example, orthogonal frequency division multiplex (Orthogonal Frequency Division Multiplex, OFDM), single-carrier frequency-division multiple access (Single-carrier Frequency-division Multiple Access, SC-FDMA), orthogonal time frequency and space (Orthogonal Time Frequency and Space, OTFS), a frequency-modulated continuous-wave (Frequency-Modulated Continuous-wave, FMCW), a pulse signal, and the like.

As for the subcarrier spacing, for example, a subcarrier spacing of an OFDM system is 30 KHz.

The guard interval is a time interval from a moment at which a signal ends to be sent to a moment at which a latest echo signal of the signal is received, and the parameter is proportional to a maximum sensing distance, for example, the guard interval may be obtained through calculation by using 2dₘₐₓ/c, where dₘₐₓ is the maximum sensing distance (belonging to the sensing demand). For example, for an echo second signal, dₘₐₓ represents a maximum distance from a transceiver point of the second signal to a signal reflection point, and in some cases, an OFDM signal cyclic prefix (Cyclic Prefix, CP) may play a role of a minimum guard interval.

As for the bandwidth, the parameter is inversely proportional to a distance resolution, and may be obtained through c/(2Δd), where Δd is the distance resolution (belonging to the sensing demand); and c is a velocity of light.

As for the burst (Burst) duration, the parameter is inversely proportional to a velocity resolution (belonging to the sensing demand). This parameter is a time span of the second signal, which is mainly used to calculate a Doppler frequency offset, and the parameter may be obtained through calculation by using c/(2f_{c}Δv), where Δv is a velocity resolution; and f_{c} is a carrier frequency of the first signal.

As for the time domain interval, the parameter may be obtained through calculation by using c/(2f_{c}v_{range}), where v_{range} is equal to a target maximum velocity minus a minimum velocity (belonging to the sensing demand), and the parameter is a time interval between two adjacent first signals.

The sending signal power, for example, takes a value every 2 dBm from −20 dBm to 23 dBm.

As for the signal format, for example, the signal format is an SRS, a DMRS, a positioning reference signal (Positioning Reference Signal, PRS), or another predefined signal, and a related sequence format.

The signal direction is, for example, a direction or beam information of the signal.

The time resource is, for example, an index of a slot in which the signal is located or a symbol index of the slot. There are two types of time resources. One is a disposable time resource, for example, one symbol sends an omnidirectional first signal. The other is a non-disposable time resource, for example, a plurality of groups of periodic time resources or discontinuous time resources (which may include a start time and an end time), each group of periodic time resources send first signals in a same direction, and beam directions on different groups of periodic time resources are different.

The frequency resource is, for example, a center frequency, a bandwidth, a resource block (Resource Block, RB) or a subcarrier, a frequency domain reference location (Point A), a start bandwidth location, and the like of the first signal.

As for the QCL relationship, for example, the first signal includes a plurality of resources, each resource is in QCL with one SSB, and a QCL type includes: Type A, Type B, Type C, or Type D.

The antenna configuration information of the second device or the third device includes at least one of the following:
an antenna array element identity (Identity, ID) used for sending and/or receiving the first signal;
an antenna port ID used for sending and/or receiving the first signal;
an antenna panel (panel) ID and an array element ID used for sending and/or receiving the first signal;
location information of an antenna array element used for sending and/or receiving the first signal relative to a local reference point on an antenna array, where the location information may be represented by Cartesian coordinates (x, y, z) or spherical coordinates (ρ, φ, θ);
location information of an antenna panel used for sending and/or receiving the first signal relative to a target local reference point on an antenna array, where the location information may be represented by Cartesian coordinates (x, y, z) or spherical coordinates (ρ, φ, θ), and location information (which may be represented by Cartesian coordinates (x, y, z) or spherical coordinates (ρ, φ, θ)) of antenna array elements that are in these selected antenna panels and that are used for sending the signal relative to a unified reference point of the antenna panel, for example, the unified reference point may be a central point of the antenna panel (panel);
first bitmap (bitmap) information of an antenna array element, where the first bitmap information indicates an antenna array element that sends and/or receives a second signal, and/or an antenna array element that does not send/or does not receive the first signal. For example, the bitmap uses “1” to indicate that a corresponding antenna array element is selected to send and/or receive a first signal, and uses “0” to indicate that a corresponding array element is not selected, and vice versa, that is, the bitmap uses “0” to indicate that a corresponding antenna array element is selected to send and/or receive a first signal, and uses “1” to indicate that a corresponding array element is not selected;
second bitmap information of the array panel, where the second bitmap information indicates an antenna panel that sends and/or receives the first signal and/or an antenna panel that does not send/or does not receive the first signal. For example, the bitmap uses “1” to indicate that a corresponding panel is selected to send and/or receive a first signal, and uses “0” to indicate that a corresponding panel is not selected, and vice versa, that is, the bitmap uses “0” to indicate that a corresponding panel is selected to send and/or receive a first signal, and uses “1” to indicate that a corresponding panel is not selected. For a selected panel, the antenna configuration information may further include first bitmap information of an antenna array element in the selected panel; or
antenna array element amplitude phase gain information, that is, antenna array element pattern (pattern) information.

Optionally, the method further includes at least one of the following:
the first device obtains first information, where the first information is communication-related information and is used by the second device to determine the first configuration information; or
the first device obtains second information of the reference node of the sensing service or the integrated sensing and communication service, the second information being used by the second device to obtain a random phase measurement result and/or a reference path parameter measurement result.

For example, the first device may obtain the first information, determine the first configuration information based on the first information, and send the second configuration information to the second device.

For example, the first device may obtain the second information of the reference node, and may obtain a random phase measurement result and/or a reference path parameter measurement result based on the second information. For the random phase measurement result, refer to related description in the foregoing embodiment. The reference path parameter measurement result may be performing measurement on reference path parameters to obtain a measurement value of each reference path parameter. The reference path parameter may include at least one of the following:
a Doppler frequency of a reference path, or a Doppler frequency and a change rate of the Doppler frequency;
a delay of a reference path, or a delay and a change rate of the delay;
an azimuth angle of departure of a reference path, or an azimuth angle of departure and a change rate of the azimuth angle of departure;
a pitch angle of departure of a reference path, or a pitch angle of departure and a change rate of the pitch angle of departure;
an azimuth angle of arrival of a reference path, or an azimuth angle of arrival and a change rate of the azimuth angle of arrival;
a pitch angle of arrival of a reference path, or a pitch angle of arrival and a change rate of the pitch angle of arrival;
an amplitude of a reference path, or an amplitude and a change rate of the amplitude; or
a phase of a reference path, or a phase and a change rate of the phase.

Optionally, the reference path may be an LOS path or a first signal reflection path from a reference node.

Optionally, the first information includes at least one of the following:
channel state information between the first device and the second device;
channel state information between the first device and the third device;
channel state information between the second device and the third device;
cascaded channel state information from the first device to the reference node of the sensing service or the integrated sensing and communication service, and from the reference node to the second device;
cascaded channel state information from the second device to the reference node, and from the reference node to the first device;
cascaded channel state information from the second device to the reference node, and from the reference node to the third device;
cascaded channel state information from the third device to the reference node, and from the reference node to the second device;
cascaded channel state information from the second device to the reference node, and from the reference node to the second device;
communication parameter configuration information between the first device and the second device;
communication parameter configuration information between the first device and the third device; or
communication parameter configuration information between the second device and the third device.

The channel state information may include at least one of uplink channel state information, downlink channel state information, a channel coherence time, or the like. The cascaded channel state information may include at least one of uplink cascaded channel state information, downlink cascaded channel state information, a cascaded channel coherence time, or the like. The communication parameter configuration information may include at least one of uplink communication parameter configuration information, downlink communication parameter configuration information, or the like. A configuration item of the communication parameter configuration information is the same as or similar to a configuration item of the first configuration information. To avoid repetition, details are not described herein again.

This embodiment of this application is described below by using examples.

Case 1: For sensing between a base station and UE or echo sensing of UE, the first information may include at least one of the following:
channel state information between the base station and the UE, at least including: uplink channel state information, downlink channel state information, and a channel coherence time;
cascaded channel state information from the base station to a reference node, and from the reference node to the UE, at least including: uplink cascaded channel state information, downlink cascaded channel state information, and a cascaded channel coherence time; or
communication parameter configuration information between the base station and the UE, including uplink communication parameter configuration information and downlink communication parameter configuration information.

Case 2: For sensing in which UE 1 sends a sensing signal and UE 2 receives the sensing signal, the first information may include at least one of the following:
channel state information between UE 1 and UE 2, at least including: uplink and/or downlink channel state information and a channel coherence time between UE 1 and UE 2;
cascaded channel state information from UE 1 to a reference node, and from the reference node to UE 2, at least including: uplink and/or downlink cascaded channel state information and a cascaded channel coherence time from UE 1 to a reference node, and from the reference node to UE 2;
cascaded channel state information from UE 2 to a reference node, and from the reference node to UE 1, at least including: uplink and/or downlink cascaded channel state information and a cascaded channel coherence time from UE 2 to a reference node, and from the reference node to UE 1;
channel state information between UE 1 and a base station, at least including: uplink and/or downlink channel state information and a channel coherence time between UE 1 and the base station;
channel state information between UE 2 and a base station, at least including: uplink and/or downlink channel state information and a channel coherence time between UE 2 and the base station;
communication parameter configuration information between UE 1 and UE 2;
communication parameter configuration information between UE 1 and a base station, including uplink communication parameter configuration information and downlink communication parameter configuration information; or
communication parameter configuration information between UE 2 and a base station, including uplink communication parameter configuration information and downlink communication parameter configuration information.

Optionally, the second information includes at least one of the following:
a location of the reference node;
a velocity value of the reference node;
a velocity direction of the reference node; or
antenna panel orientation information of the reference node.

Optionally, the first device is a network side device, and the method further includes:
in a case that the receiving node of the signal related to the sensing service or the integrated sensing and communication service is the first device or the second device, the first device obtains third information of the second device, where the third information is capability information of the second device, and is used by the first device to obtain a random phase measurement result and/or a reference path parameter measurement result;
or
in a case that the receiving node of the signal related to the sensing service or the integrated sensing and communication service is the third device, the first device obtains third information of at least one of the second device or the third device, where the third information is used by the first device to determine that the second device is the transmitting node of the signal related to the sensing service or the integrated sensing and communication service, and determine that the third device is the receiving node of the signal related to the sensing service or the integrated sensing and communication service.

Specifically, in a case that the receiving node of the signal related to the sensing service or the integrated sensing and communication service is the first device or the second device, the first device obtains third information of the second device, and may obtain a random phase measurement result and/or a reference path parameter measurement result based on the third information and the first signal. For the random phase measurement result and the reference path parameter measurement result, refer to related description in the foregoing embodiment, and details are not described herein again.

In a case that the receiving node of the signal related to the sensing service or the integrated sensing and communication service is the third device, the first device obtains capability information of at least one of the second device or the third device, to determine a transmitting device and a receiving device of the first signal or the second signal.

Optionally, the third information of the second device or the third device includes at least one of the following:
antenna information of the second device or the third device;
state information of the second device or the third device;
transmit power information of the second device or the third device;
receiving sensitivity information of the second device or the third device;
battery level information of the second device or the third device; or computing capability information of the second device or the third device.

The antenna information may include a total quantity of antenna ports, an antenna formation, and the like. The state information may include a velocity value, a velocity direction, an orientation of an antenna panel, and the like. The transmit power information may include information such as average transmit power, maximum transmit power, and receiver sensitivity.

Optionally, the method further includes:
in a case that the receiving node of the signal related to the sensing service or the integrated sensing and communication service is the first device or the second device, the first device obtains fourth information of the second device, where the fourth information is random phase related information, and is used by the first device to determine whether random phase measurement needs to be performed;
or
in a case that the receiving node of the signal related to the sensing service or the integrated sensing and communication service is the third device, the first device obtains fourth information of at least one of the second device or the third device, where the fourth information is used for at least one of the following: the first device determines whether random phase measurement needs to be performed, the first device determines that the second device is the transmitting node of the signal related to the sensing service or the integrated sensing and communication service, or determine that the third device is the receiving node of the signal related to the sensing service or the integrated sensing and communication service.

The random phase related information may be understood as prior information of the random phase.

For example, in a case that the receiving node of the signal related to the sensing service or the integrated sensing and communication service is the first device or the second device, the first device may determine whether to perform random phase measurement based on the random phase related information, and may perform random phase measurement based on the first signal in a case of determining that random phase measurement needs to be performed. In a case that the receiving node of the signal related to the sensing service or the integrated sensing and communication service is the third device, the first device may determine whether to perform random phase measurement based on the fourth information of the second device, and may perform random phase measurement based on the first signal in a case of determining that random phase measurement needs to be performed. In addition, the first device may further determine the transmitting device and the receiving device of the first signal or the second signal based on the fourth information of the second device and the fourth information of the third device.

Optionally, the fourth information of the second device or the third device includes at least one of the following:
a random phase value or a random phase value range of at least one antenna port of the second device or the third device;
a difference between a first random phase value of at least one antenna port of the second device or the third device and a second random phase value of at least one antenna port of the second device or the third device, the first random phase value being a random phase value used when the second device performs a first transmitting behavior, and the second random phase value being a random phase value used when the second device or the third device performs a second transmitting behavior;
a difference between a random phase value of at least one antenna port of the second device or the third device and a random phase value of a second reference port, the second reference port being an antenna port of the second device or the third device;
indication information of at least two antenna ports that are of antenna ports of the second device or the third device and that have a same random phase;
information about a mapping relationship between at least two antenna ports that are of antenna ports of the second device or the third device and that have a same random phase and physical antennas;
information about physical antennas mapped to at least two antenna ports that are of antenna ports of the second device or the third device and that have a same random phase;
port quantity information of at least one group of antenna ports that are of antenna ports of the second device or the third device and that have a same random phase;
random phase difference indication information of some or all of antenna ports of the second device or the third device;
antenna switching mode indication information of the second device or the third device;
input/output parameter relationship information of a power amplifier of at least one antenna port of the second device or the third device; or
antenna polarization mode indication information of the second device or the third device.

For a difference between a first random phase value of at least one antenna port of the second device or the third device and the second random phase value of at least one antenna port of the second device or the third device, the first transmitting behavior and the second transmitting behavior may be understood as two adjacent uplink transmitting behaviors. For example, the first transmitting behavior is an uplink transmitting behavior of the second device or the third device before uplink and downlink switching, and the second transmitting behavior is an uplink transmitting behavior of the second device or the third device after uplink and downlink switching. That is, a difference between the first random phase value and the second random phase value is a difference between random phase values of at least one antenna port of the second device or the third device before and after uplink and downlink switching, namely, a difference obtained by subtracting the random phase value used before the uplink and downlink switching from the random phase value used after the uplink and downlink switching, or a difference obtained by subtracting the random phase value used after the uplink and downlink switching from the random phase value used before the uplink and downlink switching.

For a difference between a random phase value of at least one antenna port of the second device or the third device and a random phase value of a second reference port, the second reference port is an antenna port of the second device or the third device, and the at least one antenna port is an antenna port different from the second reference port.

Indication information of at least two antenna ports that are of antenna ports of the second device or the third device and that have a same random phase may be, for example, indexes of the at least two antenna ports that are of antenna ports of the second device or the third device and that have a same random phase.

The information about the mapping relationship between an antenna port and a physical antenna is a correspondence between a port index and a physical antenna index.

The information about the physical antenna includes at least one of the following:
location information of the physical antenna, that is, location information (which may be represented by Cartesian coordinates (x, y, z) or spherical coordinates (ρ, φ, θ)) of the physical antenna relative to a local reference point on the antenna array of the first device. The local reference point may be any physical antenna location of the antenna array of the first device, or a physical center location of the antenna panel of the first device;
orientation information (which may be represented by spherical coordinates (φ, θ)) of the physical antenna; or
a 2D/3D radiation pattern of the physical antenna.

The random phase difference indication information of some or all of antenna ports of the second device or the third device is indication information indicating whether random phases of at least some (including all) of antenna ports of the second device or the third device are the same/different, for example, a bitmap is used for indication. In an optional method, “0000” indicates that random phases of four ports of the UE are different from each other; ‘0110’ indicates that a random phase of Port 1 is the same as that of Port 2, and a random phase of Port 0 is the same as that of Port 3; and ‘1111’ indicates that random phases of the four ports are different from each other.

The antenna switching mode indication information includes: 1T4R/1T2R/2T4R/2T2R/4T4R/mTnR, n≥1, m≥1. For example, 2T4R indicates that a quantity of transmit antennas of the first device in a same uplink slot is 2, and a quantity of receive antennas of the first device in a same downlink slot is 4.

The input/output parameter relationship information of a power amplifier (Power Amplifier, PA) of at least one antenna port of the second device or the third device is, for example, an input/output amplitude and/or phase relationship information of a power amplifier of at least one antenna port of the second device or the third device, including an amplitude ratio of the input/output of the PA, a phase difference of the input/output, an amplitude relationship curve of the input/output, and a phase relationship curve of the input/output.

The antenna polarization mode is a polarization mode (vertical polarization/horizontal polarization/cross polarization/circular polarization) of a transmit and/or receive antenna.

Optionally, that the first device performs a sensing-related operation based on the first random phase measurement result includes:
The first device sends second configuration information to the first device based on the first random phase measurement result, where the second configuration information is used for the sensing service or the integrated sensing and communication service;
or
the first device determines a measurement value of a sensing measurement quantity based on the first random phase measurement result and the first signal.

In an implementation, the first signal is used only for random phase measurement. In this case, the first device may send second configuration information to the first device based on the first random phase measurement result, so that the first device may send a second signal based on the second configuration information. The second signal is the signal related to the sensing service or the integrated sensing and communication service. It should be noted that, the second configuration information may be the same as or similar to the first configuration information. Details are not described herein again.

In another implementation, in addition to being used for random phase measurement, the first signal is also used for sensing measurement. In this case, the first device determines a measurement value of a sensing measurement quantity based on the first random phase measurement result and the first signal. The first device may calibrate, based on the first random phase measurement result, the random phase in the first signal sent by the first device, to determine an accurate measurement value of the sensing measurement quantity.

The sensing measurement quantity may include at least one of the following: a first-level measurement quantity, where the first-level measurement quantity may be a received signal/original channel information, and specifically, includes at least one of the following: a complex-valued response result of a received signal, a complex-valued response result of a received channel, an amplitude, a phase, an I branch and an operation result thereof, a Q branch and an operation result thereof, where operations in the I branch/Q branch operation result may include at least one of the following: addition, subtraction, multiplication, division, matrix addition, matrix subtraction, matrix multiplication, matrix transposition, trigonometric relationship operation, square root operation, power operation, and the like, and threshold detection results, maximum/minimum value extraction results, and the like of the foregoing operation results; the operations further include FFT/IFFT, discrete Fourier transform (Discrete Fourier Transform, DFT)/inverse discrete Fourier transform (Inverse Discrete Fourier Transform, IDFT), 2-dimensional fast Fourier transform (2D-FFT), 3-dimensional fast Fourier transform (3D-FFT), matched filtering, an autocorrelation operation, wavelet transform, digital filtering, and the like, and threshold detection results, maximum/minimum value extraction results, and the like of the foregoing operation results;
a second-level measurement quantity (a basic measurement quantity), including: a delay, Doppler, an angle, an intensity, and multidimensional combination representation thereof;
a third-level measurement quantity (a basic attribute/state), including: a distance, a velocity, an orientation, a spatial location, and an acceleration; or
a fourth-level measurement quantity (an advanced attribute/state), including: whether a target exists, a trajectory, an action, an expression, a vital sign, a quantity, an imaging result, weather, air quality, a shape, a material, and a component.

It should be noted that, a measurement value of the third-level measurement quantity and/or the fourth-level measurement quantity may also be referred to as a sensing result.

Optionally, the sensing measurement quantity may further include corresponding label information, and specifically, may include at least one of the following:
identity information of a sensing signal;
sensing measurement configuration identity information;
sensing service information (such as a sensing service ID);
a data subscription ID;
measurement quantity purposes (communication, sensing, and communication and sensing);
time information;
sensing node information (such as UE ID, a node location, and a device orientation);
sensing link information (such as a sensing link sequence number and a transmitter/receiver node identity);
measurement quantity description information (a form such as an amplitude value, a phase value, or a complex value of a combination of an amplitude and a phase); a resource type (such as a time-domain measurement result and a frequency-domain resource measurement result); or
measurement quantity indicator information (such as a signal-to-noise ratio (Signal-to-Noise Ratio, SNR) and a sensing SNR).

Optionally, after the first device sends second configuration information to the first device based on the first random phase measurement result, the method further includes:
The first device receives a second signal from the second device, where the second signal is a signal related to the sensing service or the integrated sensing and communication service;
the first device determines a second random phase measurement result based on the second signal; and
the first device sends the second random phase measurement result to the third device, or the first device determines the measurement value of the sensing measurement quantity based on the second signal and the second random phase measurement result.

For example, the second random phase measurement result may include a random phase value of each antenna port that is in the second device and that sends the second signal.

Specific descriptions are provided below with reference to examples.

In a case that the first device is a receiving device of a sensing signal, for example, sensing between a base station and UE, the first device is a base station; and for sensing in which UE 1 sends a sensing signal, and UE 2 receives the sensing signal, the first device is UE 2. The first device may receive a second signal from the second device, determine a second random phase measurement result based on the second signal, and may determine a measurement value of a sensing measurement quantity based on the second signal and the second random phase measurement result, for example, calibrate, based on the second random phase measurement result, CSI determined based on the second signal, to determine the measurement value of the sensing measurement quantity based on the calibrated CSI.

In a case that the first device is not the receiving device of the sensing signal, for example, for sensing in which UE 1 sends a sensing signal, and UE 2 receives the sensing signal, the first device is a base station. The first device may receive the second signal from the second device, determine the second random phase measurement result based on the second signal, and send the second random phase measurement result to the receiving device of the sensing signal, that is, the third device. In this way, the third device may determine a measurement value of a sensing measurement quantity based on the second signal and the second random phase measurement result.

Optionally, after the first device sends second configuration information to the first device based on the first random phase measurement result, the method further includes:
The first device receives a second signal from the second device, where the second signal is a signal related to the sensing service or the integrated sensing and communication service;
the first device determines a random phase calibration parameter or a random phase calibration manner based on the second signal; and
the first device determines the measurement value of the sensing measurement quantity based on the random phase calibration parameter or the random phase calibration manner and the second signal, where
the random phase calibration parameter includes a reference path parameter measurement value, and the random phase calibration manner includes at least one of obtaining a channel state information CSI quotient or obtaining a CSI conjugate product.

In an implementation, the first device may eliminate the random phase by using a reference path parameter estimation method. Specifically, the first device may determine a reference path parameter measurement value based on the second signal, and may further eliminate a random phase based on the reference path parameter measurement value. For example, the first device may calibrate, based on the reference path parameter measurement value, CSI calculated based on the second signal, and may determine a measurement value of a sensing measurement quantity based on the calibrated CSI. For details, refer to the reference path-based random phase calibration principle. Details are not described herein again.

In another implementation, the first device may eliminate a random phase by using a CSI quotient operation, a CSI conjugate product operation, and the like. Specifically, the first device may calculate a CSI quotient or a CSI conjugate product based on the second signal, and determine a measurement value of a sensing measurement quantity based on the CSI quotient or the CSI conjugate product. For details, refer to the CSI quotient/CSI conjugate product-based random phase calibration principle. Details are not described herein again.

Optionally, a time-frequency pattern of the first signal is different from a time-frequency pattern of the second signal.

In this embodiment, in a case that the first signal is different from the second signal, the time-frequency pattern of the first signal is different from the time-frequency pattern of the second signal.

It should be noted that, the foregoing implementations in this embodiment of this application may be properly combined according to an actual requirement.

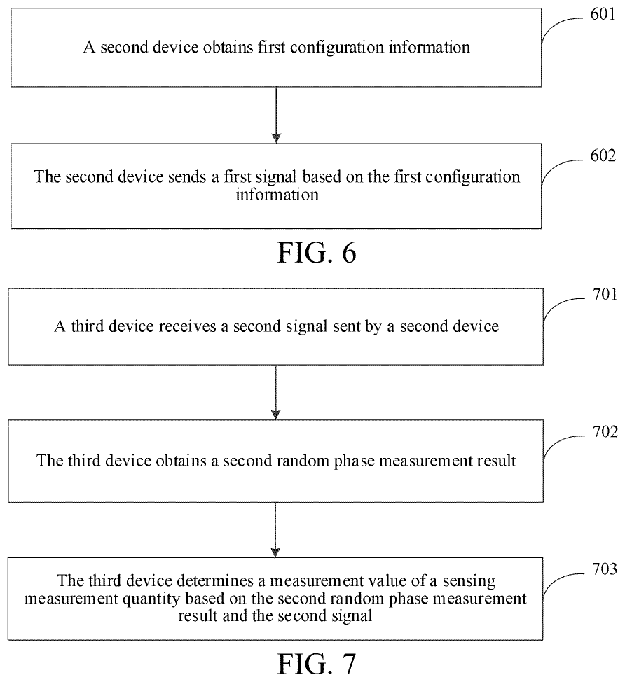

Refer to FIG. 6, FIG. 6 is a flowchart of a sensing method according to an embodiment of this application. The method may be performed by a second device, as shown in FIG. 6, including the following steps.

Step 601: A second device obtains first configuration information, where the first configuration information is used for random phase measurement of an antenna port of the second device, the second device is a terminal, and the second device is a transmitting node of a signal related to a sensing service or an integrated sensing and communication service.

Step 602: The second device sends a first signal based on the first configuration information, where the first signal is used for random phase measurement of the antenna port of the second device.

Optionally, at least one antenna port of the second device sends the first signal in at least two slots of at least one time unit, and random phases of the first signal sent in the same time unit are the same;
or
at least two antenna ports of the second device send the first signal in at least one slot of at least one time unit, and random phases of the first signal sent in the same time unit are the same.

Optionally, a same antenna port of the second device sends the first signal in different slots of a same time unit with same power.

In this embodiment, it is ensured that the same antenna port of the second device sends the first signal in different slots of a same time unit with the same power. In this way, the impact of the transmit power on random phase measurement may be reduced.

Optionally, the method further includes at least one of the following:

The second device sends third information of the second device to the first device, where the third information is capability information of the second device, and is used by the first device to obtain a random phase measurement result and/or a reference path parameter measurement result; or
the second device sends fourth information of the second device to the first device, where the fourth information is random phase related information, and is used by the second device to determine whether random phase measurement needs to be performed.

Optionally, the third information of the second device includes at least one of the following:
antenna information of the second device;
state information of the second device;
transmit power information of the second device;
receiving sensitivity information of the second device;
battery level information of the second device; or
computing capability information of the second device.

Optionally, the fourth information of the second device includes at least one of the following:
a random phase value or a random phase value range of at least one antenna port of the second device;
a difference between a first random phase value of at least one antenna port of the second device and a second random phase value of at least one antenna port of the second device, the first random phase value being a random phase value used when the second device performs a first transmitting behavior, and the second random phase value being a random phase value used when the second device performs a second transmitting behavior;
a difference between a random phase value of at least one antenna port of the second device and a random phase value of a second reference port, the second reference port being an antenna port of the second device;
indication information of at least two antenna ports that are of antenna ports of the second device and that have a same random phase;
information about a mapping relationship between at least two antenna ports that are of antenna ports of the second device and that have a same random phase and physical antennas;
information about physical antennas mapped to at least two antenna ports that are of antenna ports of the second device and that have a same random phase;
port quantity information of at least one group of antenna ports that are of antenna ports of the second device and that have a same random phase;
random phase difference indication information of some or all of antenna ports of the second device;
antenna switching mode indication information of the second device;
input/output parameter relationship information of a power amplifier of at least one antenna port of the second device; or antenna polarization mode indication information of the second device.

Optionally, the first configuration information is further used for measurement of a sensing measurement quantity, and the first signal is further used for measurement of a sensing measurement quantity.

In this embodiment, the first configuration information and the second configuration information are the same configuration information. The first signal and the second signal are the same signal. That is, the first signal is used not only for random phase measurement but also for sensing measurement.

Optionally, the method further includes:
The second device obtains second configuration information, where the second configuration information is determined based on a random phase measurement result of the antenna port of the second device; and
the second device sends a second signal based on the second configuration information, the second signal being a signal related to the sensing service or the integrated sensing and communication service.

In an implementation, the second device may receive second configuration information from the first device, and send a second signal based on the second configuration information.

In another implementation, the second device may receive a first random phase measurement result from the first device, determine second configuration information based on the first random phase measurement result, and send a second signal based on the second configuration information.

Optionally, that the second device obtains second configuration information includes:
The second device receives a first random phase measurement result of the antenna port of the second device; and
the second device determines second configuration information based on the first random phase measurement result.

Optionally, the method further includes:
The second device receives an echo signal of the second signal; and
the second device determines a measurement value of a sensing measurement quantity based on the first random phase measurement result and the echo signal.

Specifically, for echo sensing of UE, the UE may receive an echo signal of the second signal sent by the UE, and may further determine a measurement value of a sensing measurement quantity based on the echo signal of the second signal and the first random phase measurement result.

It should be noted that, for an implementation of this embodiment, refer to related descriptions in the embodiment shown in FIG. 5. Details are not described herein again.

Refer to FIG. 7, FIG. 7 is a flowchart of a sensing method according to an embodiment of this application. The method may be performed by a third device, as shown in FIG. 7, including the following steps.

Step 701: A third device receives a second signal sent by a second device, where the second signal is a signal related to a sensing service or an integrated sensing and communication service, the third device is a terminal, and the third device is a receiving node of the signal related to the sensing service or the integrated sensing and communication service.

Step 702: The third device obtains a second random phase measurement result, where the second random phase measurement result is a random phase measurement result obtained through measurement based on the second signal.

Step 703: The third device determines a measurement value of a sensing measurement quantity based on the second random phase measurement result and the second signal.

For example, for sensing in which UE 1 sends a sensing signal, and UE 2 receives the sensing signal, UE 2 may receive the second signal sent by UE 1, and may obtain a random phase measurement result obtained through measurement based on the second signal, that is, the second random phase measurement result, and may further determine, based on the second random phase measurement result and the second signal, the measurement value of the sensing measurement quantity.

Optionally, that the third device obtains a second random phase measurement result includes:
The third device receives the second random phase measurement result from a first device, the first device being a network side device;
or
the third device obtains the second random phase measurement result based on the second signal.

In an implementation, for sensing in which UE 1 sends a sensing signal, and UE 2 receives the sensing signal, a network side device may perform random phase measurement based on the second signal, to obtain the second random phase measurement result, and sends the second random phase measurement result to UE 2.

In another implementation, for sensing in which UE 1 sends a sensing signal, and UE 2 receives the sensing signal, UE 2 may perform random phase measurement based on the second signal, to obtain the second random phase measurement result.

Optionally, the method further includes:
The third device receives a first random phase measurement result from a first device; and
the third device sends second configuration information to the second device based on the first random phase measurement result, where the second configuration information is used for the sensing service or the integrated sensing and communication service.

For sensing in which UE 1 sends a sensing signal and UE 2 receives the sensing signal, UE 2 may receive a first random phase measurement result from a base station (that is, the first device), further determine second configuration information based on the first random phase measurement result, and send the second configuration information to UE 1.

It should be noted that, for an implementation of this embodiment, refer to related descriptions in the embodiment shown in FIG. 5. Details are not described herein again.

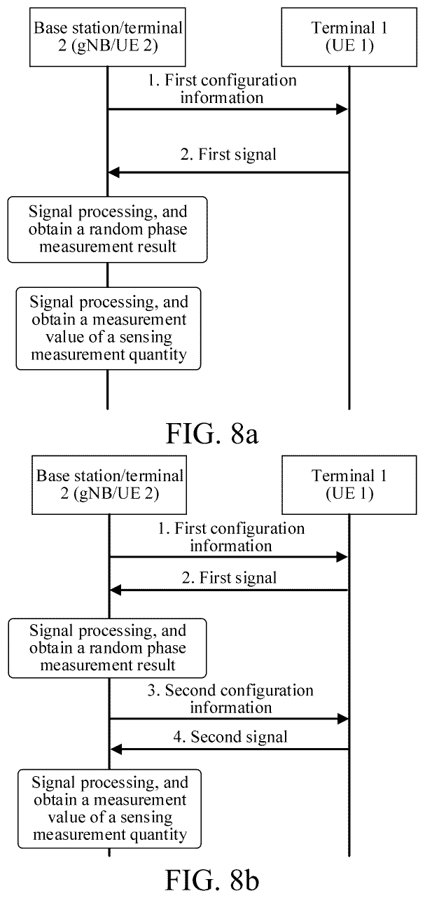

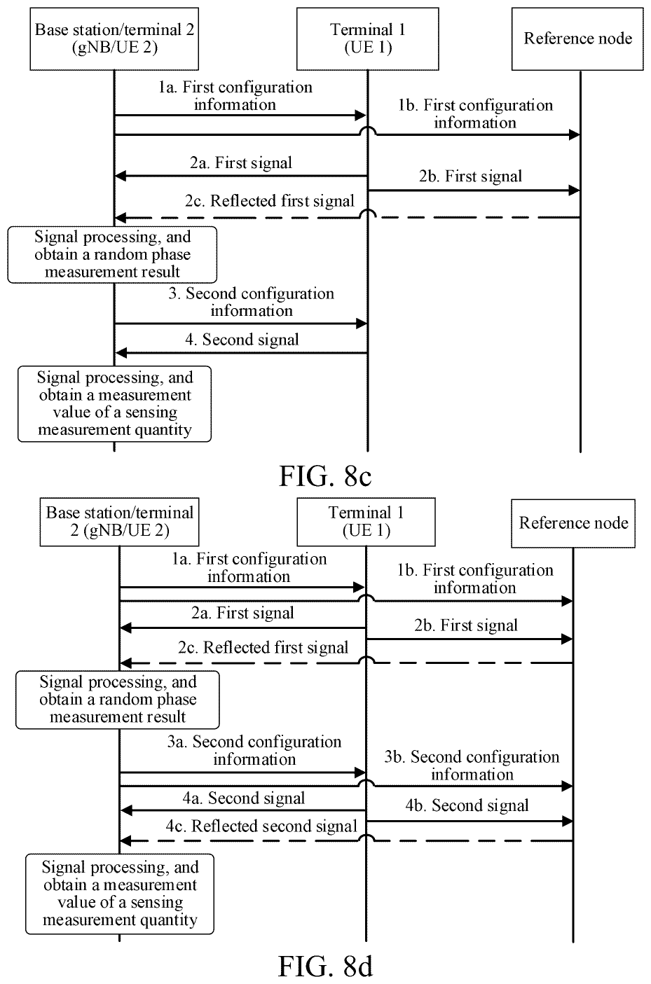

For ease of description of the sensing method provided in this embodiment of this application, with reference to FIG. 8a to FIG. 10d, the following three application scenarios are used as examples for description.

Scenario 1: As shown in FIG. 8a to FIG. 8b, the first device is a base station (gNB), and the second device is a terminal (UE 1). The sensing method provided in this embodiment of this application may include the following steps.

Step 1: The base station sends first configuration information to UE 1, where the first configuration information is used for performing antenna port random phase measurement of UE 1. For the first configuration information, refer to related description in the foregoing embodiment. Details are not described herein again.

Optionally, before step 1, the base station obtains first information, and the first information is used for assisting in determining the first configuration information. The first information includes at least one of following:
channel state information between UE 1 and a base station, at least including: uplink channel state information, downlink channel state information, and a channel coherence time;
cascaded channel state information from UE 1 to a reference node, and from the reference node to the base station, at least including: uplink cascaded channel state information, downlink cascaded channel state information, and a cascaded channel coherence time, where the reference node may be an RIS, a BSC, or another passive device or object for assisting in sensing; or
communication parameter configuration information between UE 1 and a base station, including uplink communication parameter configuration information and downlink communication parameter configuration information.

Optionally, before step 1, the base station obtains second information of the reference node, where the second information is used for assisting the base station in obtaining a random phase measurement result and/or a reference path parameter measurement result. The second information includes: a location, a velocity value, a velocity direction, and antenna panel orientation information of the reference node.

Optionally, before step 1, the base station obtains third information of UE 1, where the third information is used for assisting the base station in obtaining a random phase measurement result and/or a reference path parameter measurement result. The third information includes at least one of the following:
antenna information of UE 1, including: a total quantity of antenna ports and an antenna formation;
state information of UE 1, including: a velocity value, a velocity direction, and an antenna panel orientation;
information such as average transmit power, maximum transmit power, and receiver sensitivity of UE 1;
battery level information of UE 1; or
computing capability information of UE 1.

Optionally, before step 1, the base station obtains fourth information of UE 1. The fourth information is used for determining whether uplink random phase measurement needs to be performed. The fourth information includes at least one of the following:
a random phase value or a random phase value range of at least one antenna port of UE 1;
a difference between random phase values of at least one antenna port before and after uplink and downlink switching of UE 1, that is, a difference obtained by subtracting the random phase value used before the uplink and downlink switching from the random phase value used after the uplink and downlink switching, or a difference obtained by subtracting the random phase value used after the uplink and downlink switching from the random phase value used before the uplink and downlink switching;
a random phase value difference between at least one first port of UE 1 and a reference port, where the reference port may be any antenna port of UE 1, and the first port is an antenna port that is of UE 1 and that is different from the reference port;
indexes of at least two antenna ports that are of UE 1 and that have a same random phase;
indexes of at least two antenna ports that are of UE 1 and that have different random phases;
a mapping relationship between at least two antenna ports that are of UE 1 and that have a same random phase and physical antennas, that is, a correspondence between a port index and a physical antenna index;
information about physical antennas mapped to at least two antenna ports that are of UE 1 and that have a same random phase, including:
location information of the physical antenna;
orientation information of the physical antenna;
a 2D/3D radiation pattern of the physical antenna;
a quantity of ports of at least one group of antenna ports that are of UE 1 and that have a same random phase;
indication information indicating whether random phases of at least some (including all) antenna ports of UE 1 are the same/different;
indication information of an antenna switching mode of UE 1;
input and output amplitude and/or phase relationship information of a power amplifier of at least one antenna port of UE 1; or
antenna polarization information of UE 1.

Optionally, the base station or UE 1 sends first configuration information to the reference node.

Step 2: UE 1 sends a first signal based on the first configuration information, where the first signal is used for random phase measurement. The first signal may satisfy at least one of the following conditions:
for a same antenna port, the first signal is sent in at least two different uplink slots of a same uplink cycle;
for a same antenna port, when the first signal is sent in different uplink slots of a same uplink cycle, power remains constant; or
a time-frequency pattern of the first signal may be different from a time-frequency pattern of the second signal, and the second signal is a signal used for performing a sensing service.

The base station obtains the first random phase measurement result based on the first signal. For an obtaining method, refer to (4) Method for estimating random phases of different antenna ports and (3) Method for estimating random phases of different moments.

Step 3: The base station sends second configuration information to UE 1 based on the first random phase measurement result, where the second configuration information is used for performing a sensing/integrated sensing and communication service.

Step 4: UE 1 sends a second signal based on the second configuration information, and the base station obtains a CSI quotient or a CSI conjugate product based on the received second signal, and further obtains a measurement value of a sensing measurement quantity; or obtains a second random phase measurement result, and further obtains a measurement value of a sensing measurement quantity.

Step 5: Optionally, the base station may send the measurement value of the sensing measurement quantity to a sensing function network element.

It should be noted that: (1) If random phase estimation and calibration need to be performed on a plurality of continuous groups of uplink channel estimates/received second signals, step 1 to step 5 may be repeated until the plurality of obtained groups of uplink channel estimates/received second signals meet a sensing service requirement.

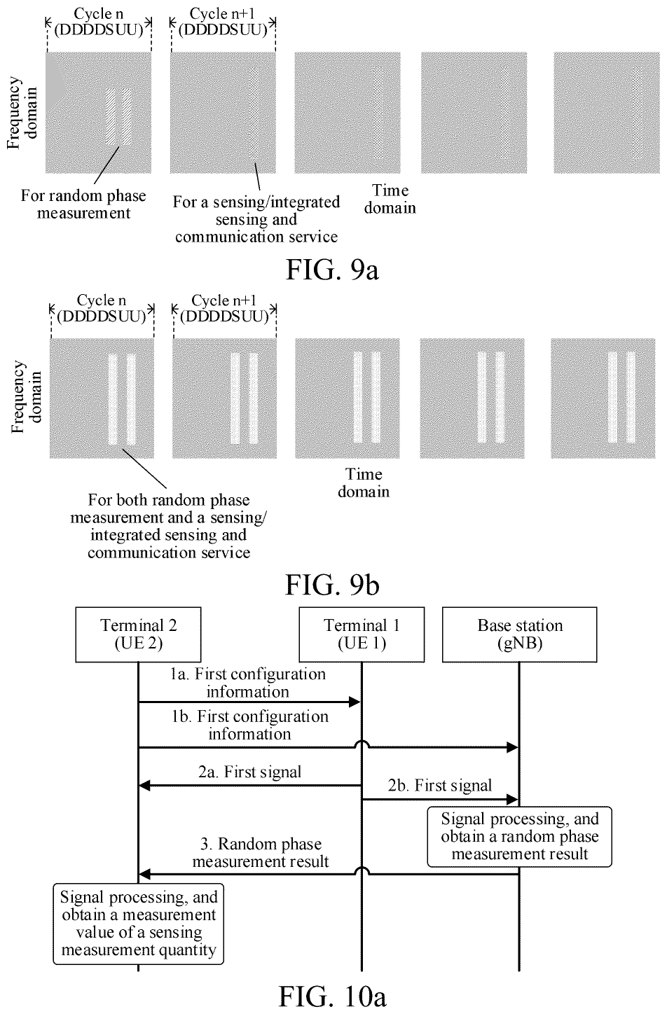

(2) The second configuration information and the first configuration information may be the same configuration information, and the second signal and the first signal may be the same signal, that is, as shown in FIG. 8a. In this case, it may be considered that operations of step 3 to step 4 are incorporated into step 1 to step 2. That is, after step 1 and step 2, the first device sequentially completes operations of random phase estimation/calibration and obtaining the measurement value of the sensing measurement quantity. To further explain, FIG. 9a and FIG. 9b are schematic diagrams of two possible signal configurations. FIG. 9a corresponds to Case 1: perform step 1 to step 5; and FIG. 9b corresponds to Case 2: perform only Step 1, Step 2, and Step 5.

Scenario 2: As shown in FIG. 8c to FIG. 8d, the first device is UE, and the second device is another UE. The sensing method provided in this embodiment of this application may include the following steps.

Step 1: For example, step 1 may include step 1a and step 1b shown in FIG. 8c or FIG. 8d, and there are the following several cases:

(1) For a case in which UE 1 is a second signal transmitting device, and UE 2 is a second signal receiving device:
a base station sends first configuration information to UE 1 and UE 2, where the first configuration information is used for performing antenna port random phase measurement of UE 1; or
a base station sends first configuration information to UE 1; or
UE 2 sends first configuration information to UE 1.

(2) For a case in which UE 2 is a first signal transmitting device, and UE 1 is a first signal receiving device:
a base station sends first configuration information to UE 1 and UE 2, where the first configuration information is used for performing antenna port random phase measurement of UE 2; or
a base station sends first configuration information to UE 2; or
UE 1 sends first configuration information to UE 2.

Optionally, before step 1, at least any one of the base station, UE 1, and UE 2 obtains first information, and the first information is used for assisting in determining the second configuration information.

The first information includes at least one of the following:
channel state information between UE 1 and UE 2, at least including: (uplink and/or downlink) channel state information and a channel coherence time between UE 1 and UE 2;
cascaded channel state information from UE 1 to a reference node, and from the reference node to UE 2, at least including: (uplink and/or downlink) cascaded channel state information and a cascaded channel coherence time from UE 1 to a reference node, and from the reference node to UE 2; the reference node may be a reconfigurable intelligent surface (Reconfigurable Intelligent Surface, RIS), a backscatter (Backscatter, BSC), or another passive device or object for assisting in sensing;
channel state information between UE 1 and a base station, at least including: (uplink and/or downlink) channel state information and a channel coherence time between UE 1 and the base station;
channel state information between UE 2 and a base station, at least including: (uplink and/or downlink) channel state information and a channel coherence time between UE 2 and the base station;
communication parameter configuration information between UE 1 and UE 2;
communication parameter configuration information between UE 1 and a base station, including uplink communication parameter configuration information and downlink communication parameter configuration information; or
communication parameter configuration information between UE 2 and a base station, including uplink communication parameter configuration information and downlink communication parameter configuration information.

Optionally, before step 1, at least any one of the base station, UE 1, and UE 2 obtains second information of the reference node, where the second information is used for assisting at least any one of the base station, UE 1, and UE 2 in obtaining a random phase measurement result and/or a reference path parameter measurement result. The second information includes: a location, a velocity value, a velocity direction, and antenna panel orientation information of the reference node.

Optionally, before step 1, the base station obtains third information of UE 1 and/or UE 2, and the third information is used for assisting in determining a transmitting device and a receiving device of the second signal. The third information includes at least one of the following:
antenna information of UE 1 and/or UE 2, including: a total quantity of antenna ports and an antenna formation;
state information of UE 1 and/or UE 2, including: a velocity value, a velocity direction, and an antenna panel orientation;
information such as average transmit power, maximum transmit power, and receiver sensitivity of UE 1 and/or UE 2;
battery level information of UE 1 and/or UE 2; or
computing capability information of UE 1 and/or UE 2.

Optionally, before step 1, the base station obtains fourth information of UE 1 and/or UE 2. The fourth information is used for determining whether uplink random phase measurement needs to be performed, and is used for assisting in determining a transmitting device and a receiving device of the second signal.

The fourth information includes at least one of the following:
a random phase value or a random phase value range of at least one antenna port of UE 1 and/or UE 2;
a difference between random phase values of at least one antenna port before and after uplink and downlink switching of UE 1 and/or UE 2, that is, a difference obtained by subtracting the random phase value used before the uplink and downlink switching from the random phase value used after the uplink and downlink switching, or a difference obtained by subtracting the random phase value used after the uplink and downlink switching from the random phase value used before the uplink and downlink switching;
a random phase value difference between at least one first port of UE 1 and/or UE 2 and a reference port, where the reference port may be any antenna port of UE 1 and/or UE 2, and the first port is an antenna port that is of UE 1 and/or UE 2 and that is different from the reference port;
indexes of at least two antenna ports that are of UE 1 and/or UE 2 and that have a same random phase;
a mapping relationship between at least two antenna ports that are of UE 1 and/or UE 2 and that have a same random phase and physical antennas, that is, a correspondence between a port index and a physical antenna index;
information about physical antennas mapped to at least two antenna ports that are of UE 1 and/or UE 2 and that have a same random phase, including:
location information of the physical antenna;
orientation information of the physical antenna;
a 2D/3D radiation pattern of the physical antenna;
a quantity of ports of at least one group of antenna ports that are of UE 1 and/or UE 2 and that have a same random phase;
indication information indicating whether random phases of at least some (including all) antenna ports of UE 1 and/or UE 2 are the same/different;
indication information of an antenna switching mode of UE 1 and/or UE 2;
input and output amplitude and/or phase relationship information of a power amplifier of at least one antenna port of UE 1 and/or UE 2; or
antenna polarization information of UE 1 and/or UE 2.

Optionally, at least one of the base station, UE 2, or UE 1 sends first configuration information to the reference node.

Step 2: For example, step 2 may include step 2a and step 2b shown in FIG. 8c or FIG. 8d, and there are the following several cases.

(1) UE 1 and/or UE 2 sends a first signal based on the first configuration information, where the first signal is used for random phase measurement. A base station receives the first signal, and obtains a first random phase measurement result based on the received first signal.

Optionally, the base station sends the first random phase measurement result to UE 1 and/or UE 2, and a receiver of the first random phase measurement result is a second signal receiver.

(2) UE 1 sends a first signal based on the first configuration information, and UE 2 receives the first signal, and obtains a first random phase measurement result based on the received first signal.

(3) UE 2 sends a first signal based on the first configuration information, and UE 1 receives the first signal, and obtains a first random phase measurement result based on the received first signal.

The first signal may satisfy at least one of the following conditions:
for a same antenna port, the first signal is sent in at least two different uplink slots of a same uplink cycle;
for a same antenna port, when the first signal is sent in different uplink slots of a same uplink cycle, power remains constant; or
a time-frequency pattern of the first signal may be different from a time-frequency pattern of the second signal, and the second signal is a signal used for performing a sensing service.

Step 3: For example, step 3 may include step 3 shown in FIG. 8c or step 3a and step 3b shown in FIG. 8d, and there are the following several cases:

(1) the base station sends second configuration information to UE 1 and UE 2 based on the first random phase measurement result, where the second configuration information is used for performing a sensing/integrated sensing and communication service;

(2) UE 2 sends second configuration information to UE 1 based on the first random phase measurement result; and

(3) UE 1 sends second configuration information to UE 2 based on the first random phase measurement result.

Step 4: For example, step 4 may include step 4 shown in FIG. 8c or step 4a and step 4b shown in FIG. 8d, and there are the following several cases:

(1) UE 1 sends a second signal based on second configuration information, and UE 2 obtains a CSI quotient or a CSI conjugate product based on the received second signal, and further obtains a measurement value of a sensing measurement quantity; or UE 2 obtains a second random phase measurement result based on the received second signal, and further obtains a measurement value of a sensing measurement quantity;

(2) UE 1 sends a second signal based on second configuration information, and the base station and UE 2 receive the second signal. The base station obtains a second random phase measurement result based on the received second signal, and sends the second random phase measurement result to UE 2. UE 2 obtains a measurement value of a sensing measurement quantity based on the received second signal and the second random phase measurement result;

(3) UE 2 sends a second signal based on the second configuration information, and UE 1 obtains a CSI quotient or a CSI conjugate product based on the received second signal, and further obtains a measurement value of a sensing measurement quantity; or UE 1 obtains a second random phase measurement result based on the received second signal, and further obtains a measurement value of a sensing measurement quantity; and

(4) UE 2 sends a second signal based on second configuration information, and the base station and UE 1 receive the second signal. The base station obtains a second random phase measurement result based on the received second signal, and sends the second random phase measurement result to UE 1. UE 1 obtains a measurement value of a sensing measurement quantity based on the received second signal and the second random phase measurement result;

Step 5: Optionally, UE 1 or UE 2 sends the measurement value of the sensing measurement quantity to a base station or a sensing function network element.

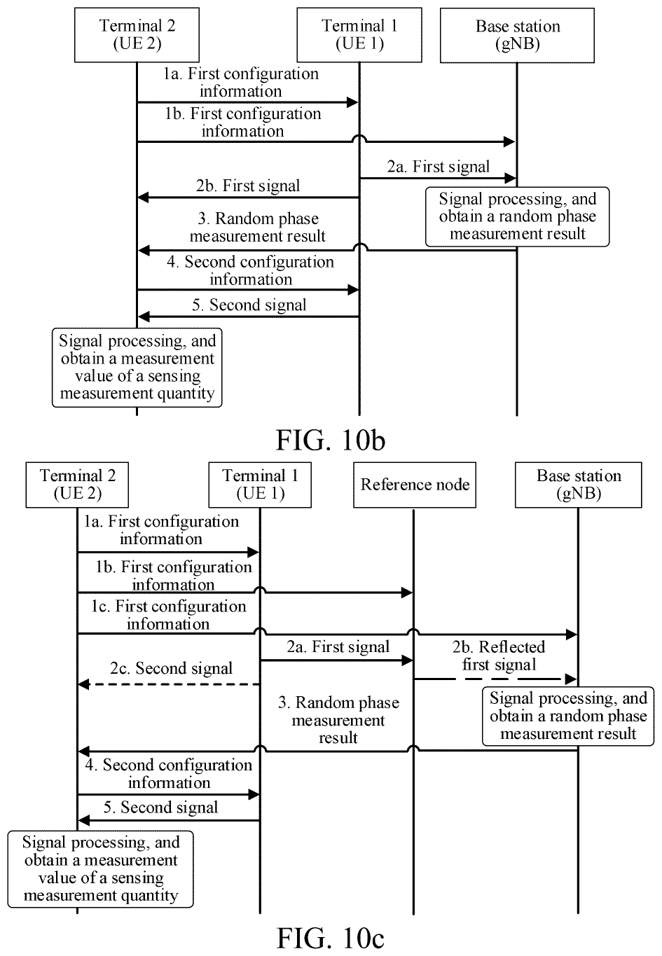

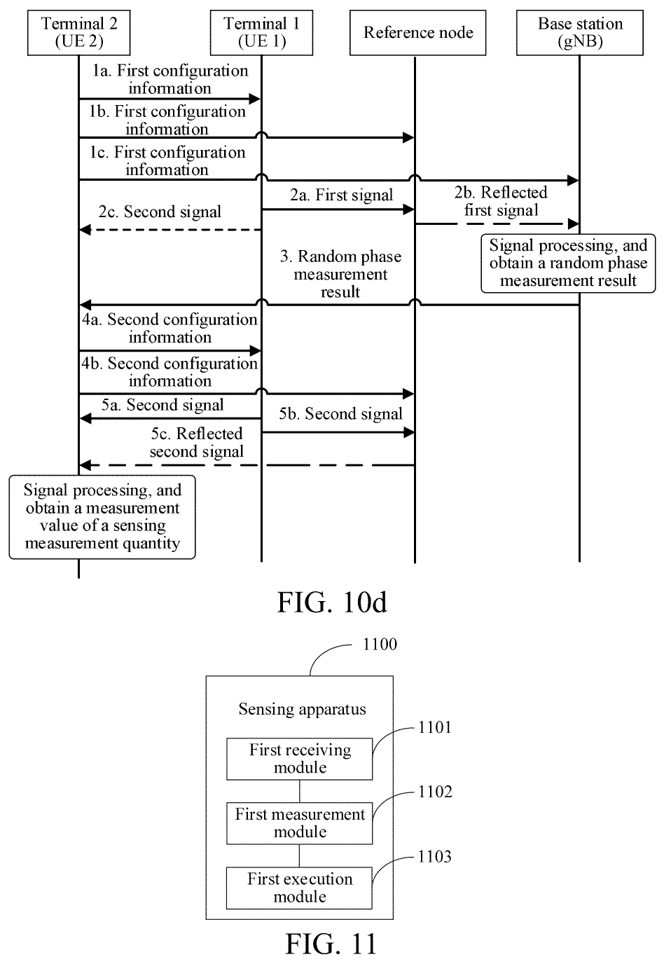

It should be noted that, for a problem of limited computing capability of the UE, a signal processing process of random phase estimation may be performed by the base station, and then the base station sends a random phase measurement result to UE (UE 2) that is used as a second signal receiving device. Corresponding to FIG. 8a to FIG. 8d, FIG. 10a to FIG. 10d are schematic flowcharts of obtaining a random phase measurement value by a base station in four cases. In addition, it should be noted that in a case that the base station obtains the random phase measurement result, the UE (UE 2) that is used as the second signal receiving device may also simultaneously receive the first signal, and obtain random phase measurement results of some ports of UE (UE 1) that is used as a second signal transmitting device.

Scenario 3: The second signal receiving device and the transmitting device are same UE. The sensing method provided in this embodiment of this application may include the following steps.

Step 1: A base station sends first configuration information to UE, where the first configuration information is used for performing antenna port random phase measurement of the UE.

Optionally, before step 1, the base station obtains first information. The first information is used for assisting in determining the first configuration information. For the first information, refer to related description of the first information in Scenario 1, and details are not described herein again.

Alternatively, the UE sends first configuration information to the base station, where the first configuration information is used for performing antenna port random phase measurement of the UE.

Optionally, before step 1, the UE obtains first information, and the first information is used for assisting in determining the first configuration information. For the first information, refer to related description of the first information in Scenario 1, and details are not described herein again.

Optionally, before step 1, the base station obtains second information of the reference node. The second information is used for assisting the base station in obtaining a random phase measurement result and/or a reference path parameter measurement result. The second information includes: a location, a velocity value, a velocity direction, and antenna panel orientation information of the reference node.

Optionally, before step 1, the base station obtains third information of UE, where the third information is used for assisting the base station in obtaining a random phase measurement result and/or a reference path parameter measurement result. The third information includes at least one of the following:
antenna information of UE, including: a total quantity of antenna ports and an antenna formation;
state information of UE, including: a velocity value, a velocity direction, and an antenna panel orientation;
information such as average transmit power, maximum transmit power, and receiver sensitivity of UE;
battery level information of UE; or
computing capability information of UE.

Optionally, the base station or the UE sends first configuration information to the reference node.

Step 2: The UE sends a first signal based on the first configuration information, where the first signal is used for random phase measurement. For this step, refer to step 2. Details are not described herein again.

Step 3: The UE determines second configuration information based on the first random phase measurement result, where the second configuration information is used for performing a sensing/integrated sensing and communication service.

Step 4: The UE sends a second signal based on the second configuration information, and receives an echo signal of the second signal.

Step 5: The UE further obtains a measurement value of a sensing measurement quantity based on the first random phase measurement result and the echo signal of the second signal.

Step 6: Optionally, the UE sends the measurement value of the sensing measurement quantity to a base station or a sensing function network element.

In conclusion, in this embodiment of this application, through random phase measurement, the device that sends an uplink sensing/integrated sensing and communication signal does not need to provide hardware and configuration information thereof related to the random phase, and has a wide application range. In addition, impact of the random phase on uplink sensing performance is reduced, and sensing/integrated sensing and communication performance is improved.

It should be noted that, the sensing method provided in this embodiment of this application may be performed by a sensing apparatus, or a control module configured to perform the sensing method in the sensing apparatus. In this embodiment of this application, the sensing apparatus provided in this embodiment of this application is described by using an example in which the sensing apparatus performs the sensing method.

With reference to FIG. 11, FIG. 11 is a structural diagram of a sensing apparatus according to an embodiment of this application. As shown in FIG. 11, the sensing apparatus 1100 includes:
a first receiving module 1101, configured to receive a first signal sent by a second device, where the first signal is used for random phase measurement of an antenna port of the second device, the second device is a terminal, and the second device is a transmitting node of a signal related to a sensing service or an integrated sensing and communication service;
a first measurement module 1102, configured to perform random phase measurement based on the first signal, to obtain a first random phase measurement result; and
a first execution module 1103, configured to perform a first operation, where the first operation includes at least one of the following:
sending the first random phase measurement result to the second device or a third device, the first device being a network side device, the third device being a terminal, and the third device being a receiving node of the signal related to the sensing service or the integrated sensing and communication service; or
performing a sensing-related operation based on the first random phase measurement result.

Optionally, at least one antenna port of the second device sends the first signal in at least two slots of at least one time unit, and random phases of the first signal sent in the same time unit are the same;
or
at least two antenna ports of the second device send the first signal in at least one slot of at least one time unit, and random phases of the first signal sent in the same time unit are the same.

Optionally, the first random phase measurement result includes at least one of the following:
a random phase value of at least one antenna port of the second device;
a difference between a random phase value of at least one antenna port of the second device in at least one first uplink moment and a random phase value of a reference moment, the first uplink moment and the reference moment being different uplink moments in which the antenna port of the second device sends the first signal;
a difference between a random phase value of at least one antenna port of the second device and a random phase value of a first reference port, the first reference port being an antenna port of the second device;
indication information of at least two antenna ports that are of antenna ports of the second device and that have a same random phase; or
indication information of at least two antenna ports that are of antenna ports of the second device and that have different random phases.

Optionally, the apparatus further includes a first sending module, specifically configured to perform at least one of the following:
sending first configuration information to the second device;
sending first configuration information to the third device; or
sending first configuration information to a reference node of the sensing service or the integrated sensing and communication service, where
the first configuration information is used for random phase measurement of the antenna port of the second device.

Optionally, the first configuration information includes at least one of the following:
a waveform type, a subcarrier spacing, a guard interval, a bandwidth, burst duration, a time domain interval, sending signal power, a signal format, a signal direction, a time resource, a frequency resource, a quasi co-location, QCL, relationship, antenna configuration information of the second device, or antenna configuration information of the third device.

Optionally, the apparatus further includes a first obtaining module, configured to perform at least one of the following:
obtaining first information, where the first information is communication-related information and is used by the second device to determine the first configuration information;
or
obtaining second information of the reference node of the sensing service or the integrated sensing and communication service, the second information being used by the second device to obtain a random phase measurement result and/or a reference path parameter measurement result.

Optionally, the first information includes at least one of the following:
channel state information between the first device and the second device;
channel state information between the first device and the third device;
channel state information between the second device and the third device;
cascaded channel state information from the first device to the reference node of the sensing service or the integrated sensing and communication service, and from the reference node to the second device;
cascaded channel state information from the second device to the reference node, and from the reference node to the first device;
cascaded channel state information from the second device to the reference node, and from the reference node to the third device;
cascaded channel state information from the third device to the reference node, and from the reference node to the second device;
cascaded channel state information from the second device to the reference node, and from the reference node to the second device;
communication parameter configuration information between the first device and the second device;
communication parameter configuration information between the first device and the third device; or
communication parameter configuration information between the second device and the third device.

Optionally, the second information includes at least one of the following:
a location of the reference node;
a velocity value of the reference node;
a velocity direction of the reference node; or
antenna panel orientation information of the reference node.

Optionally, the first device is a network side device, and the apparatus further includes a second obtaining module, configured to:
in a case that the receiving node of the signal related to the sensing service or the integrated sensing and communication service is the first device or the second device, obtain third information of the second device, where the third information is capability information of the second device, and is used by the first device to obtain a random phase measurement result and/or a reference path parameter measurement result;
or
in a case that the receiving node of the signal related to the sensing service or the integrated sensing and communication service is the third device, obtain third information of at least one of the second device or the third device, where the third information is used by the first device to determine that the second device is the transmitting node of the signal related to the sensing service or the integrated sensing and communication service, and determine that the third device is the receiving node of the signal related to the sensing service or the integrated sensing and communication service.

Optionally, the third information of the second device or the third device includes at least one of the following:
antenna information of the second device or the third device;
state information of the second device or the third device;
transmit power information of the second device or the third device;
receiving sensitivity information of the second device or the third device;
battery level information of the second device or the third device; or
computing capability information of the second device or the third device.

Optionally, the apparatus further includes a third obtaining module, configured to:
in a case that the receiving node of the signal related to the sensing service or the integrated sensing and communication service is the first device or the second device, obtain fourth information of the second device, where the fourth information is random phase related information, and is used by the first device to determine whether random phase measurement needs to be performed;
or
in a case that the receiving node of the signal related to the sensing service or the integrated sensing and communication service is the third device, obtain fourth information of at least one of the second device or the third device, where the fourth information is used for at least one of the following: the first device determines whether random phase measurement needs to be performed, the first device determines that the second device is the transmitting node of the signal related to the sensing service or the integrated sensing and communication service, or determine that the third device is the receiving node of the signal related to the sensing service or the integrated sensing and communication service.

Optionally, the fourth information of the second device or the third device includes at least one of the following:
a random phase value or a random phase value range of at least one antenna port of the second device or the third device;
a difference between a first random phase value of at least one antenna port of the second device or the third device and a second random phase value of at least one antenna port of the second device or the third device, the first random phase value being a random phase value used when the second device performs a first transmitting behavior, and the second random phase value being a random phase value used when the second device or the third device performs a second transmitting behavior;
a difference between a random phase value of at least one antenna port of the second device or the third device and a random phase value of a second reference port, the second reference port being an antenna port of the second device or the third device;
indication information of at least two antenna ports that are of antenna ports of the second device or the third device and that have a same random phase;
information about a mapping relationship between at least two antenna ports that are of antenna ports of the second device or the third device and that have a same random phase and physical antennas;
information about physical antennas mapped to at least two antenna ports that are of antenna ports of the second device or the third device and that have a same random phase;
port quantity information of at least one group of antenna ports that are of antenna ports of the second device or the third device and that have a same random phase;
random phase difference indication information of some or all of antenna ports of the second device or the third device;
antenna switching mode indication information of the second device or the third device;
input/output parameter relationship information of a power amplifier of at least one antenna port of the second device or the third device; or
antenna polarization mode indication information of the second device or the third device.

Optionally, the first execution module is specifically configured to:
send second configuration information to the first device based on the first random phase measurement result, where the second configuration information is used for the sensing service or the integrated sensing and communication service;
or
determine a measurement value of a sensing measurement quantity based on the first random phase measurement result and the first signal.

Optionally, the apparatus further includes:
a second receiving module, configured to: after the sending second configuration information to the first device based on the first random phase measurement result, receive a second signal from the second device, where the second signal is a signal related to the sensing service or the integrated sensing and communication service;
a first determining module, configured to determine a second random phase measurement result based on the second signal; and
a second execution module, configured to: send the second random phase measurement result to the third device, or determine the measurement value of the sensing measurement quantity based on the second signal and the second random phase measurement result.

Optionally, the apparatus further includes:
a third receiving module, configured to: after the sending second configuration information to the first device based on the first random phase measurement result, receive a second signal from the second device, where the second signal is a signal related to the sensing service or the integrated sensing and communication service;
a second determining module, configured to determine a random phase calibration parameter or a random phase calibration manner based on the second signal; and
a third determining module, configured to determine the measurement value of the sensing measurement quantity based on the random phase calibration parameter or the random phase calibration manner and the second signal, where
the random phase calibration parameter includes a reference path parameter measurement value, and the random phase calibration manner includes at least one of obtaining a channel state information CSI quotient or obtaining a CSI conjugate product.

Optionally, a time-frequency pattern of the first signal is different from a time-frequency pattern of the second signal.

The sensing apparatus in this embodiment of this application may be an electronic device, for example, an electronic device with an operating system, or may be a component in an electronic device, for example, an integrated circuit or a chip. The electronic device may be a terminal or a network side device, or may be another device other than the terminal or the network side device. For example, the terminal may include but is not limited to the foregoing listed types of the terminal 11, the network side device may include but is not limited to the foregoing listed types of the network side device 12, and the another device may be a server, a network attached storage (Network Attached Storage, NAS), and the like. This is not specifically limited in this embodiment of this application.

The sensing apparatus provided in this embodiment of this application can implement the processes implemented in the method embodiment of FIG. 5 and achieve a same technical effect. To avoid repetition, details are not described herein again.

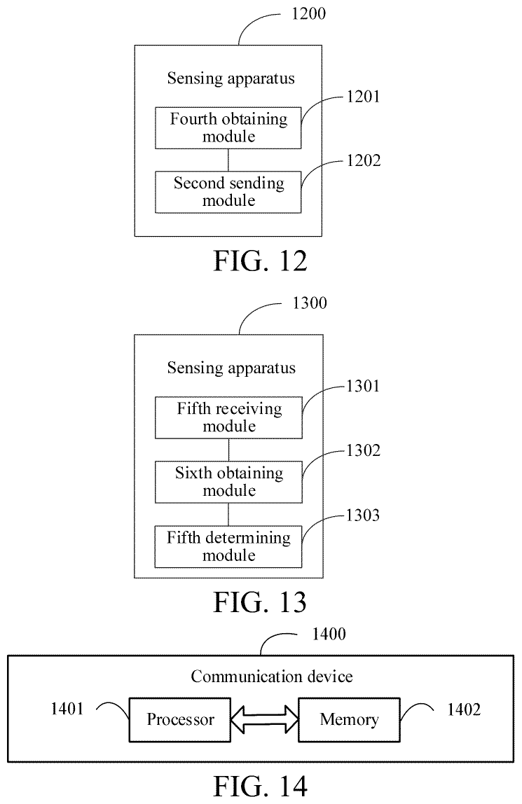

With reference to FIG. 12, FIG. 12 is a structural diagram of a sensing apparatus according to an embodiment of this application. As shown in FIG. 12, the sensing apparatus 1200 includes:
a fourth obtaining module 1201, configured to obtain first configuration information, where the first configuration information is used for random phase measurement of an antenna port of the second device, the second device is a terminal, and the second device is a transmitting node of a signal related to a sensing service or an integrated sensing and communication service; and
a second sending module 1202, configured to send a first signal based on the first configuration information, where the first signal is used for random phase measurement of the antenna port of the second device.

Optionally, a same antenna port of the second device sends the first signal in different slots of a same time unit with same power.

Optionally, the apparatus further includes a third sending module, configured to perform at least one of the following:
sending third information of the second device to the first device, where the third information is capability information of the second device, and is used by the first device to obtain a random phase measurement result and/or a reference path parameter measurement result; or
sending fourth information of the second device to the first device, where the fourth information is random phase related information, and is used by the second device to determine whether random phase measurement needs to be performed.

Optionally, the third information of the second device includes at least one of the following:
antenna information of the second device;
state information of the second device;
transmit power information of the second device;
receiving sensitivity information of the second device;
battery level information of the second device; or
computing capability information of the second device.

Optionally, the fourth information of the second device includes at least one of the following:
a random phase value or a random phase value range of at least one antenna port of the second device;
a difference between a first random phase value of at least one antenna port of the second device and a second random phase value of at least one antenna port of the second device, the first random phase value being a random phase value used when the second device performs a first transmitting behavior, and the second random phase value being a random phase value used when the second device performs a second transmitting behavior;
a difference between a random phase value of at least one antenna port of the second device and a random phase value of a second reference port, the second reference port being an antenna port of the second device;
indication information of at least two antenna ports that are of antenna ports of the second device and that have a same random phase;
information about a mapping relationship between at least two antenna ports that are of antenna ports of the second device and that have a same random phase and physical antennas;
information about physical antennas mapped to at least two antenna ports that are of antenna ports of the second device and that have a same random phase;
port quantity information of at least one group of antenna ports that are of antenna ports of the second device and that have a same random phase;
random phase difference indication information of some or all of antenna ports of the second device;
antenna switching mode indication information of the second device;
input/output parameter relationship information of a power amplifier of at least one antenna port of the second device; or
antenna polarization mode indication information of the second device.

Optionally, the first configuration information is further used for measurement of a sensing measurement quantity, and the first signal is further used for measurement of a sensing measurement quantity.

Optionally, the apparatus further includes:
a fifth obtaining module, configured to obtain second configuration information, where the second configuration information is determined based on a random phase measurement result of the antenna port of the second device; and
a fourth sending module, configured to send a second signal based on the second configuration information, the second signal being a signal related to the sensing service or the integrated sensing and communication service.

Optionally, the fifth obtaining module is specifically configured to:
receive a first random phase measurement result of the antenna port of the second device; and
determine second configuration information based on the first random phase measurement result.

Optionally, the apparatus further includes:
a fourth receiving module, configured to receive an echo signal of the second signal; and
a fourth determining module, configured to determine a measurement value of a sensing measurement quantity based on the first random phase measurement result and the echo signal.

The sensing apparatus in this embodiment of this application may be an electronic device, for example, an electronic device with an operating system, or may be a component in an electronic device, for example, an integrated circuit or a chip. The electronic device may be a terminal, or another device other than the terminal. For example, the terminal may include but is not limited to the foregoing listed types of the terminal 11. The another device may be a server, a network attached storage (Network Attached Storage, NAS), and the like. This is not specifically limited in this embodiment of this application.

The sensing apparatus provided in this embodiment of this application can implement the processes implemented in the method embodiment of FIG. 6 and achieve a same technical effect. To avoid repetition, details are not described herein again.

With reference to FIG. 13, FIG. 13 is a structural diagram of a sensing apparatus according to an embodiment of this application. As shown in FIG. 13, the sensing apparatus 1300 includes:
a fifth receiving module 1301, configured to receive a second signal sent by a second device, where the second signal is a signal related to a sensing service or an integrated sensing and communication service, the third device is a terminal, and the third device is a receiving node of the signal related to the sensing service or the integrated sensing and communication service;
a sixth obtaining module 1302, configured to obtain a second random phase measurement result, where the second random phase measurement result is a random phase measurement result obtained through measurement based on the second signal; and
a fifth determining module 1303, configured to determine a measurement value of a sensing measurement quantity based on the second random phase measurement result and the second signal.

Optionally, the sixth obtaining module is specifically configured to:
receive the second random phase measurement result from a first device, the first device being a network side device;
or
obtain the second random phase measurement result based on the second signal.

Optionally, the apparatus further includes:
a sixth receiving module, configured to receive a first random phase measurement result from a first device; and
a fifth sending module, configured to send second configuration information to the second device based on the first random phase measurement result, where the second configuration information is used for the sensing service or the integrated sensing and communication service.

The sensing apparatus in this embodiment of this application may be an electronic device, for example, an electronic device with an operating system, or may be a component in an electronic device, for example, an integrated circuit or a chip. The electronic device may be a terminal, or another device other than the terminal. For example, the terminal may include but is not limited to the foregoing listed types of the terminal 11. The another device may be a server, a network attached storage (Network Attached Storage, NAS), and the like. This is not specifically limited in this embodiment of this application.

The sensing apparatus provided in this embodiment of this application can implement the processes implemented in the method embodiment of FIG. 7 and achieve a same technical effect. To avoid repetition, details are not described herein again.

Optionally, as shown in FIG. 14, an embodiment of this application further provides a communication device 1400, including a processor 1401 and a memory 1402. The memory 1402 stores a program or instructions executable on the processor 1401. For example, when the communication device 1400 is a first device, the program or the instructions, when executed by the processor 1401, implement the steps of the sensing method embodiment on the first device side, and a same technical effect can be achieved. When the communication device 1400 is a second device, the program or the instructions, when executed by the processor 1401, implement the steps of the sensing method embodiment of the second device, and a same technical effect can be achieved. When the communication device 1400 is a third device, the program or the instructions, when executed by the processor 1401, implement the steps of the sensing method embodiment of the third device, and a same technical effect can be achieved. To avoid repetition, details are not described herein again.

An embodiment of this application further provides a terminal, including a processor and a communication interface. When the terminal is a first device, the communication interface is configured to receive a first signal sent by a second device, where the first signal is used for random phase measurement of an antenna port of the second device, the second device is a terminal, and the second device is a transmitting node of a signal related to a sensing service or an integrated sensing and communication service; the processor is configured to perform random phase measurement based on the first signal, to obtain a first random phase measurement result; the processor is further configured to perform a first operation, where the first operation includes at least one of the following: sending the first random phase measurement result to the second device or a third device, the first device being a network side device, the third device being a terminal, and the third device being a receiving node of the signal related to the sensing service or the integrated sensing and communication service; or performing a sensing-related operation based on the first random phase measurement result; or
when the terminal is a second device, the processor is configured to obtain first configuration information, where the first configuration information is used for random phase measurement of an antenna port of the second device, the second device is a terminal, and the second device is a transmitting node of a signal related to a sensing service or an integrated sensing and communication service; the communication interface is configured to send a first signal based on the first configuration information, where the first signal is used for random phase measurement of the antenna port of the second device; or
when the terminal is a third device, the communication interface is configured to receive a second signal sent by a second device, where the second signal is a signal related to a sensing service or an integrated sensing and communication service, the third device is a terminal, and the third device is a receiving node of the signal related to the sensing service or the integrated sensing and communication service; the processor is configured to obtain a second random phase measurement result, where the second random phase measurement result is a random phase measurement result obtained through measurement based on the second signal; and the processor is further configured to determine a measurement value of a sensing measurement quantity based on the second random phase measurement result and the second signal.

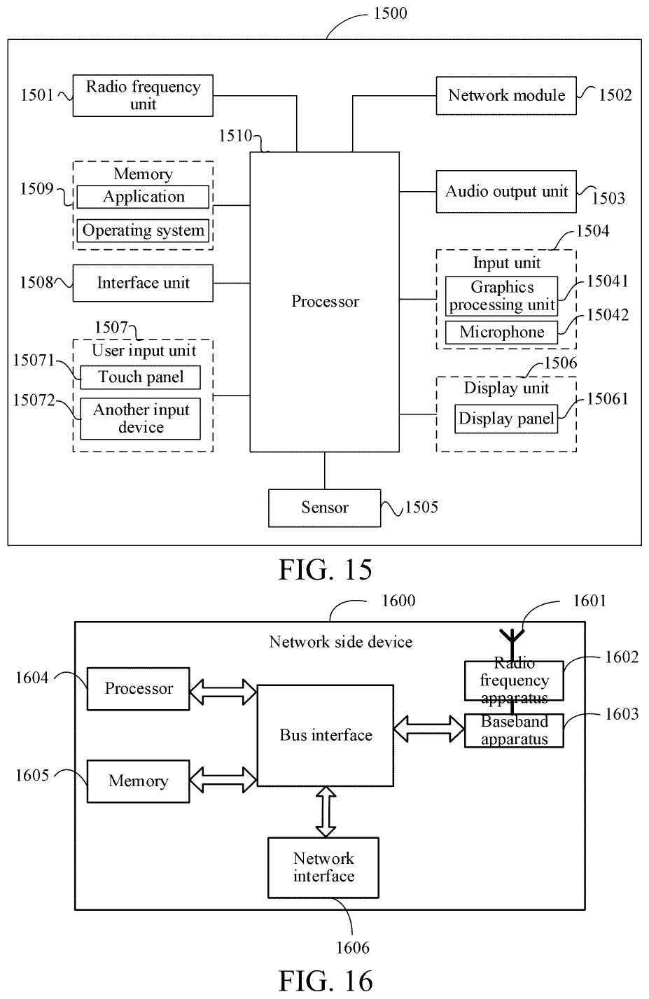

This terminal embodiment is corresponding to the foregoing terminal-side method embodiment. Each implementation process and implementation of the foregoing method embodiment may be applied to this terminal embodiment, and a same technical effect can be achieved. Specifically, FIG. 15 is a schematic diagram of a hardware structure of a terminal according to an embodiment of this application.

The terminal 1500 includes but is not limited to: at least some of the following components: a radio frequency unit 1501, a network module 1502, an audio output unit 1503, an input unit 1504, a sensor 1505, a display unit 1506, a user input unit 1507, an interface unit 1508, a memory 1509, and a processor 1510.

A person skilled in the art may understand that the terminal 1500 may further include a power supply (such as a battery) that supplies power to each component. The power supply may be logically connected to the processor 1510 through a power management system, to implement functions such as charging and discharging management, and power consumption management by using the power management system. The terminal structure shown in FIG. 15 constitutes no limitation on the terminal, and the terminal may include more or fewer components than those shown in the figure, or combine some components, or have different component arrangements. Details are not described herein again.

It should be understood that, in this embodiment of this application, the input unit 1504 may include a graphics processing unit (Graphics Processing Unit, GPU) 15041 and a microphone 15042, and the graphics processing unit 15041 processes image data of a still picture or a video obtained by an image capture apparatus (such as a camera) in a video capture mode or an image capture mode. The display unit 1506 may include a display panel 15061, and the display panel 15061 may be configured in a form of a liquid crystal display, an organic light-emitting diode, or the like. The user input unit 1507 includes at least one of a touch panel 15071 and another input device 15072. The touch panel 15071 is also referred to as a touchscreen. The touch panel 15071 may include two parts: a touch detection apparatus and a touch controller. The another input device 15072 may include but is not limited to a physical keyboard, a functional button (such as a volume control button or a power on/off button), a trackball, a mouse, and a joystick. Details are not described herein again.

In this embodiment of this application, after receiving downlink data from a network side device, the radio frequency unit 1501 may transmit the downlink data to the processor 1510 for processing. In addition, the radio frequency unit 1501 may send uplink data to the network side device. Generally, the radio frequency unit 1501 includes but is not limited to an antenna, an amplifier, a transceiver, a coupler, a low noise amplifier, a duplexer, and the like.

The memory 1509 may be configured to store a software program or an instruction and various data. The memory 1509 may mainly include a first storage area for storing a program or instructions and a second storage area for storing data. The first storage area may store an operating system, and an application or an instruction required by at least one function (for example, a sound playing function or an image playing function). In addition, the memory 1509 may be a volatile memory or a non-volatile memory, or the memory 1509 may include a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1509 in this embodiment of this application includes but is not limited to these memories and any memory of another proper type.

The processor 1510 may include one or more processing units. Optionally, an application processor and a modem processor are integrated into the processor 1510. The application processor mainly processes an operating system, a user interface, an application, or the like. The modem processor mainly processes a wireless communication signal, for example, a baseband processor. It may be understood that the foregoing modem processor may not be integrated into the processor 1510.

When the terminal is a first device, the radio frequency unit 1501 is configured to receive a first signal sent by a second device, where the first signal is used for random phase measurement of an antenna port of the second device, the second device is a terminal, and the second device is a transmitting node of a signal related to a sensing service or an integrated sensing and communication service; the processor 1510 is configured to perform random phase measurement based on the first signal, to obtain a first random phase measurement result; the processor 1510 is further configured to perform a first operation, where the first operation includes at least one of the following: sending the first random phase measurement result to the second device or a third device, the first device being a network side device, the third device being a terminal, and the third device being a receiving node of the signal related to the sensing service or the integrated sensing and communication service; or performing a sensing-related operation based on the first random phase measurement result; or
when the terminal is a second device, the processor 1510 is configured to obtain first configuration information, where the first configuration information is used for random phase measurement of an antenna port of the second device, the second device is a terminal, and the second device is a transmitting node of a signal related to a sensing service or an integrated sensing and communication service; the radio frequency unit 1501 is configured to send a first signal based on the first configuration information, where the first signal is used for random phase measurement of the antenna port of the second device; or
when the terminal is a third device, the radio frequency unit 1501 is configured to receive a second signal sent by a second device, where the second signal is a signal related to a sensing service or an integrated sensing and communication service, the third device is a terminal, and the third device is a receiving node of the signal related to the sensing service or the integrated sensing and communication service; the processor 1510 is configured to obtain a second random phase measurement result, where the second random phase measurement result is a random phase measurement result obtained through measurement based on the second signal; and the processor 1510 is further configured to determine a measurement value of a sensing measurement quantity based on the second random phase measurement result and the second signal.

It should be understood that the terminal provided in this embodiment of this application may implement the steps of the foregoing sensing method embodiments, and can achieve the same technical effect. To avoid repetition, details are not described herein again.

An embodiment of this application further provides a network side device, including a processor and a communication interface. The communication interface is configured to receive a first signal sent by a second device, where the first signal is used for random phase measurement of an antenna port of the second device, the second device is a terminal, and the second device is a transmitting node of a signal related to a sensing service or an integrated sensing and communication service; the processor is configured to perform random phase measurement based on the first signal, to obtain a first random phase measurement result; the processor is further configured to perform a first operation, where the first operation includes at least one of the following: sending the first random phase measurement result to the second device or a third device, the first device being a network side device, the third device being a terminal, and the third device being a receiving node of the signal related to the sensing service or the integrated sensing and communication service; or performing a sensing-related operation based on the first random phase measurement result. This network side device embodiment is corresponding to the foregoing method embodiment of the network side device. Each implementation process and implementation of the foregoing method embodiment may be applicable to this network side device embodiment, and a same technical effect can be achieved.

Specifically, an embodiment of this application further provides a network side device. As shown in FIG. 16, the network side device 1600 includes: an antenna 1601, a radio frequency apparatus 1602, a baseband apparatus 1603, a processor 1604, and a memory 1605. The antenna 1601 is connected to the radio frequency apparatus 1602. In an uplink direction, the radio frequency apparatus 1602 receives information by using the antenna 1601, and sends the received information to the baseband apparatus 1603 for processing. In a downlink direction, the baseband apparatus 1603 processes to-be-sent information, and sends the to-be-sent information to the radio frequency apparatus 1602. After processing the received information, the radio frequency apparatus 1602 sends the information through the antenna 1601.

The method performed by the network side device in the foregoing embodiment may be implemented in the baseband apparatus 1603, and the baseband apparatus 1603 includes a baseband processor.

The baseband apparatus 1603 may include, for example, at least one baseband board. A plurality of chips are provided on the baseband board. As shown in FIG. 16, one chip is, for example, a baseband processor, and is connected to the memory 1605 by using a bus interface, to invoke a program in the memory 1605 to perform the operations of the network device shown in the foregoing method embodiment.

The network side device may further include a network interface 1606. The interface is, for example, a common public radio interface (common public radio interface, CPRI).

Specifically, the network side device 1600 in this embodiment of this application further includes: instructions or a program stored in the memory 1605 and executable on the processor 1604. The processor 1604 invokes the instructions or the program in the memory 1605 to perform the method performed by the modules shown in FIG. 11, and a same technical effect is achieved. To avoid repetition, details are not described herein again.

An embodiment of this application further provides a readable storage medium. The readable storage medium stores a program or instructions. When the program or instructions are executed by a processor, the processes in the foregoing sensing method embodiment are performed, and a same technical effect can be achieved. To avoid repetition, details are not described herein again.

The processor is a processor in the terminal in the foregoing embodiment. The readable storage medium includes a computer-readable storage medium, such as a computer read-only memory (ROM), a random access memory (RAM), a magnetic disk, or an optical disc.

An embodiment of this application further provides a chip. The chip includes a processor and a communication interface, the communication interface is coupled to the processor, the processor is configured to run a program or instructions to implement the processes of the foregoing sensing method embodiment, and a same technical effect can be achieved. To avoid repetition, details are not described herein again.

It should be understood that the chip mentioned in this embodiment of this application may alternatively be referred to as a system-level chip, a system chip, a chip system, an on-chip system chip, or the like.

An embodiment of this application further provides a computer program/program product. The computer program/program product is stored in a storage medium, the computer program/program product is executed by at least one processor to implement the processes of the foregoing sensing method embodiment, and a same technical effect can be achieved. To avoid repetition, details are not described herein again.

An embodiment of this application further provides a sensing system, including a terminal and a network side device. The network side device is configured to perform the processes in FIG. 5 and each method embodiment, the terminal is configured to perform the processes in FIG. 6 or FIG. 7 and the foregoing method embodiments, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to such process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (such as a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A sensing method, comprising:
receiving, by a first device, a first signal sent by a second device, wherein the first signal is used for random phase measurement of an antenna port of the second device, the second device is a terminal, and the second device is a transmitting node of a signal related to a sensing service or an integrated sensing and communication service;
performing, by the first device, random phase measurement based on the first signal, to obtain a first random phase measurement result; and
performing, by the first device, a first operation, wherein the first operation comprises at least one of the following:
sending the first random phase measurement result to the second device or a third device, the first device being a network side device, the third device being a terminal, and the third device being a receiving node of the signal related to the sensing service or the integrated sensing and communication service; or
performing a sensing-related operation based on the first random phase measurement result.

2. The method according to claim 1, wherein at least one antenna port of the second device sends the first signal in at least two slots of at least one time unit, and random phases of the first signal sent in the same time unit are the same;
or
at least two antenna ports of the second device send the first signal in at least one slot of at least one time unit, and random phases of the first signal sent in the same time unit are the same.

3. The method according to claim 1, wherein the first random phase measurement result comprises at least one of the following:
a random phase value of at least one antenna port of the second device;
a difference between a random phase value of at least one antenna port of the second device in at least one first uplink moment and a random phase value of a reference moment, the first uplink moment and the reference moment being different uplink moments in which the antenna port of the second device sends the first signal;
a difference between a random phase value of at least one antenna port of the second device and a random phase value of a first reference port, the first reference port being an antenna port of the second device;
indication information of at least two antenna ports that are of antenna ports of the second device and that have a same random phase; or
indication information of at least two antenna ports that are of antenna ports of the second device and that have different random phases.

4. The method according to claim 1, wherein before the receiving, by a first device, a first signal sent by a second device, the method further comprises at least one of the following:
sending, by the first device, first configuration information to the second device;
sending, by the first device, first configuration information to the third device; or
sending, by the first device, first configuration information to a reference node of the sensing service or the integrated sensing and communication service, wherein
the first configuration information is used for random phase measurement of the antenna port of the second device.

5. The method according to claim 4, wherein the first configuration information comprises at least one of the following:
a waveform type, a subcarrier spacing, a guard interval, a bandwidth, burst duration, a time domain interval, sending signal power, a signal format, a signal direction, a time resource, a frequency resource, a quasi co-location, QCL, relationship, antenna configuration information of the second device, or antenna configuration information of the third device.

6. The method according to claim 4, wherein the method further comprises at least one of the following:
obtaining, by the first device, first information, wherein the first information is communication-related information and is used by the second device to determine the first configuration information; or
obtaining, by the first device, second information of the reference node of the sensing service or the integrated sensing and communication service, the second information being used by the second device to obtain a random phase measurement result and/or a reference path parameter measurement result.

7. The method according to claim 6, wherein the first information comprises at least one of the following:
channel state information between the first device and the second device;
channel state information between the first device and the third device;
channel state information between the second device and the third device;
cascaded channel state information from the first device to the reference node of the sensing service or the integrated sensing and communication service, and from the reference node to the second device;
cascaded channel state information from the second device to the reference node, and from the reference node to the first device;
cascaded channel state information from the second device to the reference node, and from the reference node to the third device;
cascaded channel state information from the third device to the reference node, and from the reference node to the second device;
cascaded channel state information from the second device to the reference node, and from the reference node to the second device;
communication parameter configuration information between the first device and the second device;
communication parameter configuration information between the first device and the third device; or
communication parameter configuration information between the second device and the third device; or
wherein the second information comprises at least one of the following:
a location of the reference node;
a velocity value of the reference node;
a velocity direction of the reference node; or
antenna panel orientation information of the reference node.

8. The method according to claim 1, wherein the first device is a network side device, and the method further comprises:
in a case that the receiving node of the signal related to the sensing service or the integrated sensing and communication service is the first device or the second device, obtaining, by the first device, third information of the second device, wherein the third information is capability information of the second device, and is used by the first device to obtain a random phase measurement result and/or a reference path parameter measurement result;
or
in a case that the receiving node of the signal related to the sensing service or the integrated sensing and communication service is the third device, obtaining, by the first device, third information of at least one of the second device or the third device, wherein the third information is used by the first device to determine that the second device is the transmitting node of the signal related to the sensing service or the integrated sensing and communication service, and determine that the third device is the receiving node of the signal related to the sensing service or the integrated sensing and communication service.

9. The method according to claim 8, wherein the third information of the second device or the third device comprises at least one of the following:
antenna information of the second device or the third device;
state information of the second device or the third device;
transmit power information of the second device or the third device;
receiving sensitivity information of the second device or the third device;
battery level information of the second device or the third device; or
computing capability information of the second device or the third device.

10. The method according to claim 1, wherein the method further comprises:
in a case that the receiving node of the signal related to the sensing service or the integrated sensing and communication service is the first device or the second device, obtaining, by the first device, fourth information of the second device, wherein the fourth information is random phase related information, and is used by the first device to determine whether random phase measurement needs to be performed;
or
in a case that the receiving node of the signal related to the sensing service or the integrated sensing and communication service is the third device, obtaining, by the first device, fourth information of at least one of the second device or the third device, wherein the fourth information is used for at least one of the following: determining, by the first device, whether random phase measurement needs to be performed, determining, by the first device, that the second device is the transmitting node of the signal related to the sensing service or the integrated sensing and communication service, or determining that the third device is the receiving node of the signal related to the sensing service or the integrated sensing and communication service.

11. The method according to claim 10, wherein the fourth information of the second device or the third device comprises at least one of the following:
a random phase value or a random phase value range of at least one antenna port of the second device or the third device;
a difference between a first random phase value of at least one antenna port of the second device or the third device and a second random phase value of at least one antenna port of the second device or the third device, the first random phase value being a random phase value used when the second device performs a first transmitting behavior, and the second random phase value being a random phase value used when the second device or the third device performs a second transmitting behavior;
a difference between a random phase value of at least one antenna port of the second device or the third device and a random phase value of a second reference port, the second reference port being an antenna port of the second device or the third device;
indication information of at least two antenna ports that are of antenna ports of the second device or the third device and that have a same random phase;
information about a mapping relationship between at least two antenna ports that are of antenna ports of the second device or the third device and that have a same random phase and physical antennas;
information about physical antennas mapped to at least two antenna ports that are of antenna ports of the second device or the third device and that have a same random phase;
port quantity information of at least one group of antenna ports that are of antenna ports of the second device or the third device and that have a same random phase;
random phase difference indication information of some or all of antenna ports of the second device or the third device;
antenna switching mode indication information of the second device or the third device;
input/output parameter relationship information of a power amplifier of at least one antenna port of the second device or the third device; or
antenna polarization mode indication information of the second device or the third device.

12. The method according to claim 1, wherein the performing, by the first device, a sensing-related operation based on the first random phase measurement result comprises:
sending, by the first device, second configuration information to the first device based on the first random phase measurement result, wherein the second configuration information is used for the sensing service or the integrated sensing and communication service;
or
determining, by the first device, a measurement value of a sensing measurement quantity based on the first random phase measurement result and the first signal.

13. The method according to claim 12, wherein after the sending, by the first device, second configuration information to the first device based on the first random phase measurement result, the method further comprises:
receiving, by the first device, a second signal from the second device, wherein the second signal is a signal related to the sensing service or the integrated sensing and communication service;
determining, by the first device, a second random phase measurement result based on the second signal; and
sending, by the first device, the second random phase measurement result to the third device, or determining, by the first device, the measurement value of the sensing measurement quantity based on the second signal and the second random phase measurement result.

14. The method according to claim 12, wherein after the sending, by the first device, second configuration information to the first device based on the first random phase measurement result, the method further comprises:
receiving, by the first device, a second signal from the second device, wherein the second signal is a signal related to the sensing service or the integrated sensing and communication service;
determining, by the first device, a random phase calibration parameter or a random phase calibration manner based on the second signal; and
determining, by the first device, the measurement value of the sensing measurement quantity based on the random phase calibration parameter or the random phase calibration manner and the second signal, wherein
the random phase calibration parameter comprises a reference path parameter measurement value, and the random phase calibration manner comprises at least one of obtaining a channel state information CSI quotient or obtaining a CSI conjugate product.

15. The method according to claim 13, wherein a time-frequency pattern of the first signal is different from a time-frequency pattern of the second signal.

16. A sensing method, comprising:
obtaining, by a second device, first configuration information, wherein the first configuration information is used for random phase measurement of an antenna port of the second device, the second device is a terminal, and the second device is a transmitting node of a signal related to a sensing service or an integrated sensing and communication service; and
sending, by the second device, a first signal based on the first configuration information, wherein the first signal is used for random phase measurement of the antenna port of the second device.

17. A sensing method, comprising:
receiving, by a third device, a second signal sent by a second device, wherein the second signal is a signal related to a sensing service or an integrated sensing and communication service, the third device is a terminal, and the third device is a receiving node of the signal related to the sensing service or the integrated sensing and communication service;
obtaining, by the third device, a second random phase measurement result, wherein the second random phase measurement result is a random phase measurement result obtained through measurement based on the second signal; and
determining, by the third device, a measurement value of a sensing measurement quantity based on the second random phase measurement result and the second signal.

18. A first device, comprising a processor and a memory, wherein the memory stores a program or instructions executable on the processor, and the program or the instructions, when executed by the processor, implement the steps of the sensing method according to claim 1.

19. A second device, comprising a processor and a memory, wherein the memory stores a program or instructions executable on the processor, and the program or the instructions, when executed by the processor, implement the steps of the sensing method according to claim 16.

20. A third device, comprising a processor and a memory, wherein the memory stores a program or instructions executable on the processor, and the program or the instructions, when executed by the processor, implement the steps of the sensing method according to claim 17.
